(19) United States
(12) Patent Application Publication
(10) Pub. No.: US 2020/0399568 A1
(43) Pub. Date: Dec. 24, 2020

(54) Washing- And Cleaning-Active Polymer Films, Process For Their Production And Their Use

(71) Applicant: BASF SE, Ludwigshafen (DE)

(72) Inventors: Juergen DETERING, Ludwigshafen (DE); Maria DE MORAGAS, Barcelona (ES); Yannick FUCHS, Ludwigshafen (DE); Claudia ESPER, Ludwigshafen (DE); Benjamin SCHMIDT-HANSBERG, Ludwigshafen (DE); Markus MEISE, Ludwigshafen (DE); Dominik LANZINGER, Ludwigshafen (DE); Aaron WAGNER, Ludwigshafen (DE); Helmut WITTELER, Ludwigshafen (DE); Matthias ARNDT, Ludwigshafen (DE)

(21) Appl. No.: 16/643,448

(22) PCT Filed: Sep. 5, 2018
(86) PCT No.: PCT/EP2018/073863

§ 371 Date: Feb. 28, 2020

(30) Foreign Application Priority Data
Sep. 6, 2017 (EP) 17189672.3

(51) Int. Cl. C11D 17/04; C11D 3/37; C11D 17/00

(52) U.S. Cl. CPC C11D 17/042; C11D 17/0039; C11D 3/3707; C11D 3/3761

(57) ABSTRACT

The present disclosure relates to a washing- and cleaning-active polymer film which includes a mixture of at least one polymer P1) including polymerized units of at least one α,β-ethylenically unsaturated carboxylic acid or a salt thereof. The washing- and cleaning-active polymer film optionally further includes comonomers and a polyoxyalkylene ether PE). The disclosure furthermore relates to a process for producing such a washing- and cleaning-active polymer film and to a covering or coating for a detergent or cleaner portion which includes such a polymer film.

### BACKGROUND OF THE INVENTION

The present invention relates to a washing- and cleaning-active polymer film which comprises a mixture of at least one polymer P1) comprising polymerized units of at least one α,β-ethylenically unsaturated carboxylic acid or a salt thereof and optionally further comonomers and a polyoxyalkylene ether PE). The invention furthermore relates to a process for producing such a washing- and cleaning-active polymer film and to a covering or coating for a detergent or cleaner portion which comprises such a polymer film or consists thereof.

### PRIOR ART

It is known to use water-soluble films of polyvinyl alcohol (PVOH) for the portionwise packaging of liquid, gel-like and solid detergents and cleaners. The polyvinyl alcohol film dissolves at the start of the washing and cleaning process and releases the detergents and cleaners so that these can develop their effect. The advantages of the portionwise packaged detergents and cleaners (so-called single dose units or mono dose units) for the consumer are manifold. These include the avoidance of incorrect dosages, ease of handling, and the fact that the consumer does not come into physical contact with the ingredients of the detergents and cleaners. These also furthermore include aesthetic aspects which lead to a preference for the portionwise packaged detergents and cleaners. Current dosage forms can comprise a large number of separately formulated active ingredients and auxiliaries which are released individually in the cleaning process. Such multichamber systems permit, for example, the separation of incompatible ingredients and thus the creation of new formulation concepts. The fraction of polyvinyl alcohol film in the total weight of the detergent or cleaner portion (single dose unit) is between 2 and 20% by weight, according to application.

The biggest disadvantage of the polyvinyl alcohol films is that they only serve as packaging material and make no contribution at all to the washing and cleaning performance.

It is known that polymer compositions obtained by polymerizing a monomer containing acid groups in the presence of a polyether compound form stable and homogeneous products. Depending on the chemical ingredients, such polymer compositions can be obtained as water-soluble solids, and more particularly as transparent films, and therefore show potential as packaging material for Home-Care applications, e.g. in the form of single dose units of detergents and cleaners. Unlike PVOH films, films obtained by polymerization of α,β-ethylenically unsaturated acids in the presence of polyethers are washing- and cleaning-active after film dissolution, especially if the polyether is a surface-active surfactant.

WO 2005/012378 describes aqueous dispersions of water-soluble polymers of anionic monomers and their use as thickeners for aqueous systems. To produce them, anionic monomers are polymerized in the presence of two water-soluble polymers from different classes, which may, inter alia, also be polyalkylene glycols. Example 4 (page 19, lines 14-27) relates to the polymerization of acrylic acid in the presence of two different polypropylene glycols and of maltodextrin. The dispersions are used inter alia in personal care products, and in detergents and cleaners. A use in the form of films is not described.

WO 2015/000970 describes a process for producing solid polymer composition, in particular in the form of a film or in the form of a solid coating on a substrate or in particle form, in which
a) a monomer composition M) is provided which comprises
   A) at least one α,β-ethylenically unsaturated carboxylic acid, and
   B) less than 0.1% by weight, based on the total weight of the monomer composition M), of crosslinking monomers which have two or more than two polymerizable α,β-ethylenically unsaturated double bonds per molecule,
   and
b) the monomer composition M) provided in step a) is subjected to a free-radical polymerization in the presence of at least one polyether component PE) which is selected from polyetherols with a number-average molecular weight of at least 200 g/mol and their mono- and di(C₁-C₆-alkyl ethers), surfactants containing polyether groups, and mixtures thereof.

WO 2015/000969 describes the use of a gel-like polymer composition obtained by polymerization of α,β-ethylenically unsaturated acids in the presence of polyethers for automatic dishwashing (ADW) applications. WO 2015/000971 describes the use of a gel-like polymer composition as described in WO 2015/000969 for further uses, but not in the form of films.

The fabrication of films from the afore-mentioned polyacid-surfactant polymerization products is a two-step process, wherein in the first step the polymer composition is prepared and in the second step the polymer composition is subjected to film formation, e.g. by wet casting. This method allows to provide stable compositions of polyacids, and particularly polycarboxylic acids, and polyethers or polyether derivatives that cannot be provided by physical mixing or that are very difficult to mix together. Depending on the composition in said physical mixtures turbidity or phase separation is often observed. However, it would be desirable, to provide simple physical mixtures of polyacids and polyethers as component of washing- and cleaning-active polymer films. One advantage is that for physical mixtures commercially available components can be used.

F. E. Bailey et al. describe, in Polymer Preprints, American Chemical Society, Division of Polymer Chemistry, 1960, vol. 1, issue 2, p. 202-205 and the literature cited therein, the formation of molecular association complexes of ethylene oxide polymers having a very high molecular weight with polymeric acids such as polyacrylic acid in aqueous solutions.

EP 0971997 B1 describes a liquid detergent formulation comprising a nonionic surfactant and an anionic polymer. The nonionic surfactant may be an ethoxylated C₈-C₁₈ alcohol and the anionic polymer may be polyacrylic acid. The polymer has a molecular weight of more than 100 000 g/mol.

The two last-mentioned documents do not describe to use mixtures of polyacids and polyethers for the formation of washing- and cleaning-active polymer films.

Surprisingly, it has now been found that it is possible to provide polymer films which are advantageously suitable as covering or coating for producing detergent or cleaner portions from physical mixtures of certain previously prepared polyacids, and particularly certain previously prepared polycarboxylic acids, and certain polyethers.

### SUMMARY OF THE INVENTION

A first object of the invention is a washing- and cleaning-active polymer film, comprising or consisting of at least one layer obtainable by
a) providing an aqueous composition by mixing
   a polymer P1) that comprises polymerized units of at least one monomer A), selected from α,β-ethylenically unsaturated carboxylic acids, salts of α,β-ethylenically unsaturated carboxylic acids and mixtures thereof,
   a polyoxyalkylene ether PE) having at least one C₈-C₁₈-alkyl group that is unsubstituted or substituted by at least one hydroxyl group, and an average of 3 to 25 alkylene oxide units per molecule, and
   water,
   wherein at the most 30 mol % of the carboxy groups of the polymer P1) are in the deprotonated form,
   the weight ratio of the polymer P1) to the C₈-C₁₈-alkyl polyoxyalkylene ether PE) is in a range from 0.9:1 to 5:1, and
   the aqueous composition has a water content of at least 10% by weight and at most 50% by weight, based on the total weight of the aqueous composition,
b) converting the aqueous composition to a polymer film.

The invention further provides a process for producing a washing- and cleaning-active polymer film, comprising
a) providing an aqueous composition by mixing
   a polymer P1) that comprises polymerized units of at least one monomer A), selected from α,β-ethylenically unsaturated carboxylic acids, salts of α,β-ethylenically unsaturated carboxylic acids and mixtures thereof,
   a polyoxyalkylene ether PE) having at least one C₈-C₁₈-alkyl group that is unsubstituted or substituted by at least one hydroxyl group, and an average of 3 to 25 alkylene oxide units per molecule, and
   water,
   wherein at the most 30 mol % of the carboxy groups of the polymer P1) are in the deprotonated form,
   the weight ratio of the polymer P1) to the C₈-C₁₈-alkyl polyoxyalkylene ether PE) is in a range from 0.9:1 to 5:1, and
   the aqueous composition has a water content of at least 10% by weight and at most 50% by weight, based on the total weight of the aqueous composition,
b) converting the aqueous composition to a polymer film.

The invention further provides a detergent or cleaner, comprising:
A) at least one covering and/or coating, comprising or consisting of a washing- and cleaning-active polymer film as defined above in the Summary and below in the Detailed Description, or obtainable by a process as defined above in the Summary and below in the detailed description,
B) at least one surfactant,
C) optionally at least one builder,
D) optionally at least one bleach system,
E) optionally at least one further additive, which is preferably selected from enzymes, enzyme stabilizers, bases, corrosion inhibitors, antifoams, foam inhibitors, dyes, fragrances, fillers, tableting auxiliaries, disintegrants, thickeners, solubility promoters, organic solvents, electrolytes, pH extenders, perfume carriers, bitter substances, fluorescent agents, hydrotropes, antiredeposition agents, optical brighteners, graying inhibitors, shrink preventers, anticrease agents, color transfer inhibitors, antimicrobial active ingredients, antioxidants, anti-yellowing agents polymeric dispersants, antistats, ironing aids, phobicization and impregnation agents, swelling and slip-resist agents and UV absorbers, and
F) optionally water.

### DESCRIPTION OF THE INVENTION

In the process of the invention at least one polymer P1), at least one polyoxyalkylene ether PE) and water are subjected to a blending operation by common methods known to a person skilled in the art. It is of critical importance that in the mixing step no α,β-ethylenically unsaturated monomers are subjected to a free-radical polymerization in the presence of the polyoxyalkylene ether PE). It is already known to prepare film-forming polymer compositions by free-radical polymerization of a monomer composition comprising α,β-ethylenically unsaturated carboxylic acids in the presence of polyoxyalkylene ethers, e.g. from WO 2015/000969, WO 2015/000970 and WO 2015/000971. Physically mixing at least one polymer P1) and at least one polyoxyalkylene ether PE) on the one hand and polymerization of α,β-ethylenically unsaturated monomers capable of forming a polymer P1) in the presence of at least one polyoxyalkylene ether PE) on the other hand are two alternatives for the formation of washing- and cleaning-active polymer compositions, each process having its own characteristic properties. For instance, compared to the free radical polymerization process mentioned above the process of physically mixing of at least one polymer P1) and at least one polyoxyalkylene ether PE) avoids any side reactions leading to undesirable by-products that might negatively affect the properties of the film. Further, in the mixing process no exothermic reaction occurs that might lead to the necessity to remove heat from the reaction zone or to take further safety measures.

The polymer films according to the invention or produced by the process according to the invention are suitable for the packaging of washing and cleaning compositions in liquid, gel and solid form as portions. They dissolve at the start and/or in the course of the respective use (e.g. in the washing or dishwashing water), thus release the ingredients of the detergents and cleaners and contribute in dissolved form on account of their dispersing, scale-inhibiting, emulsifying and surface-active properties to the washing and cleaning performance to a considerable extent.

In the context of the present invention, the terms “detergent portion” and “cleaner portion” are understood as meaning an amount of a detergent or of a cleaner that suffices for a washing or cleaning operation taking place in an aqueous phase. This may for example be a machine washing operation, as is carried out using standard commercial washing machines. According to the invention, this term is also understood as meaning an active ingredient portion for a hand wash operation or a cleaning operation carried out by hand (as is carried out, e.g., in a hand washing basin or in a bowl). The washing- and cleaning-active polymer films according to the invention are preferably used for producing active ingredient portions for machine washing or cleaning operations.

In the context of the present invention, the term “polymer film” refers to a flat structure which has an essentially two-dimensional extension. The thickness of the films according to the invention is preferably 0.5 μm to 20 mm, particularly preferably 1 μm to 10 mm. The thickness of the polymer films of the invention is small in relation to the length and width. Preferably, the thickness of the polymer films is smaller by a factor of at least 2, more preferably of at least 5 and especially of at least 10 than the length of the greatest longitudinal axis. In a specific embodiment, the thickness of the polymer films is smaller by a factor of at least 20, more specifically at least 50, even more specifically at least 100 and very specifically at least 500 than the length of the greatest longitudinal axis. In principle, the upper value for the greatest longitudinal extent of the polymer films of the invention is uncritical. The polymer films of the invention can be produced, for example, in the form of film rolls, where the greatest length may even be in the region of 100 m or higher.

The polymer films of the invention can be in form of single layer films or multilayer films.

A multilayer film in the context of the invention is understood to mean a film composite where at least two films are permanently and fully bonded over a significant portion of their area. This is understood to mean that at least two films are permanently and fully bonded over at least 50% of their area. When two films of different size are bonded to one another, at least the film having the smaller area is permanently and fully bonded over at least 50% of its area. Thus, the multilayer films of the invention differ from known films for washing and cleaning composition portions where an individual film or 2 or more films are joined to one another by at least one weld seam. The latter films are permanently and fully bonded to one another over at most 10% of their area.

The term “multilayer film” in the context of the present invention refers to a self-supporting flat structure having at least two film layers. The maximum thickness of the multilayer films of the invention is preferably at most 30 mm, more preferably at most 20 mm, especially at most 15 mm. It will be apparent that the maximum thickness of the multilayer films of the invention depends on their field of use. Multilayer films for ensheathing or coating for a washing composition portion or cleaning composition portion preferably have a thickness of not more than 1500 μm, more preferably not more than 1000 μm.

For the purpose of the invention, the article “a” and “an” preceding an element does not exclude the presence of a plurality of such elements.

In the context of this application, compounds which can be derived from acrylic acid and methacrylic acid are sometimes referred to by adding the syllable “(meth)” to the compound derived from acrylic acid.

Suitable C₁-C₄-alkyl groups, C₁-C₇-alkyl groups, C₈-C₁₈-alkyl groups and C₁₂-C₁₈-alkyl groups are in each case linear and (above 3 carbon atoms) branched alkyl groups.

In the context of the present invention, C₁-C₄-alkyl is a linear or branched alkyl radical having 1 to 4 carbon atoms. Suitable C₁-C₄-alkyls are methyl, ethyl, n-propyl, isopropyl, n-butyl, sec-butyl, isobutyl and tert-butyl.

In the context of the present invention, C₁-C₇-alkyl is a linear or branched alkyl radical having 1 to 7 carbon atoms. Suitable C₁-C₇-alkyls are methyl, ethyl, propyl, isopropyl, n-butyl, sec-butyl, isobutyl, tert-butyl, n-pentyl, n-hexyl, n-heptyl and constitutional isomers thereof.

C₁₂-C₁₈-alkyl is a linear or branched alkyl radical having 12 to 18 carbon atoms. Suitable C₁₂-C₁₈-alkyls are dodecyl, tridecyl, tetradecyl, pentadecyl, hexadecyl, heptadecyl, octadecyl, nonadecyl, eicosyl, henicosyl, docosyl, tricosyl, tetracosyl and constitutional isomers thereof. In a preferred embodiment, they are predominantly linear C₁₂-C₁₈-alkyl radicals, as also occur in natural or synthetic fatty alcohols, and oxo alcohols.

C₈-C₁₈-alkyl is a linear or branched alkyl radical having 8 to 18 carbon atoms. Suitable C₈-C₁₈-alkyls are octyl, 2-ethylhexyl, nonyl, decyl, 2-propylheptyl, undecyl, dodecyl, tridecyl, tetradecyl, pentadecyl, hexadecyl, heptadecyl, octadecyl, nonadecyl, eicosyl, henicosyl, docosyl, tricosyl, tetracosyl and constitutional isomers thereof. In a preferred embodiment, they are predominantly linear C₈-C₁₈-alkyl radicals, as also occur in natural or synthetic fatty alcohols, and oxo alcohols.

In the context of the present application, the expression C₉C₁₁-alcohols is a mixture which comprises alcohols having 9 carbon atoms and alcohols having 11 carbon atoms. C₁₂C₁₄-alcohols are a mixture which comprises alcohols having 12 carbon atoms and alcohols having 14 carbon atoms. C₁₃C₁₅-alcohols are a mixture which comprises alcohols having 13 carbon atoms and alcohols having 15 carbon atoms. C₁₂C₁₈-alcohols are a mixture which comprises alcohols having 12 carbon atoms, alcohols having 14 carbon atoms, alcohols having 16 carbon atoms and alcohols having 18 carbon atoms.

### Polymer P1)

The polymer P1) can be prepared by free-radical polymerization of a monomer composition M) that comprises
at least one monomer A) which is selected from α,β-ethylenically unsaturated carboxylic acids, salts of α,β-ethylenically unsaturated carboxylic acids and mixtures thereof,
optionally at least one monomer B) which is selected from unsaturated sulfonic acids, salts of unsaturated sulfonic acids, unsaturated phosphonic acid, salts of unsaturated phosphonic acids and mixtures thereof, and
optionally at least one monomer C), different from A) and B).

### Monomer Composition M)

### Monomer A)

The monomer composition M) used for producing the polymer P1) comprises at least one monomer A) which is selected from α,β-ethylenically unsaturated carboxylic acids, salts of α,β-ethylenically unsaturated carboxylic acids and mixtures thereof.

In a specific embodiment, the monomer composition M) consists only of α,β-ethylenically unsaturated carboxylic acids, salts of α,β-ethylenically unsaturated carboxylic acids and mixtures thereof.

The α,β-ethylenically unsaturated carboxylic acid is preferably selected from acrylic acid, methacrylic acid, ethacrylic acid, maleic acid, fumaric acid, itaconic acid, α-chloroacrylic acid, crotonic acid, citraconic acid, mesaconic acid, glutaconic acid and aconitic acid. Suitable salts of the aforementioned acids are, in particular, the sodium, potassium and ammonium salts, and the salts with amines. The monomers A) can be used as such or as mixtures with one another. The stated weight fractions all refer to the acid form.

Preferably, the at least one α,β-ethylenically unsaturated carboxylic acid is used for the polymerization in non-neutralized form. If the α,β-ethylenically unsaturated carboxylic acids are used for the polymerization in partially neutralized form, then the acid groups are neutralized preferably to at most 50 mol %, particularly preferably to at most 30 mol %. The partial or full neutralization can also be effected during the polymerization or after the polymerization has ended.

Particularly preferably, the monomer A) is selected from acrylic acid, methacrylic acid, maleic acid, fumaric acid, itaconic acid, salts of the aforementioned carboxylic acids and mixtures thereof.

In particular, the monomer A) is selected from acrylic acid, methacrylic acid, salts of acrylic acid, salts of methacrylic acid and mixtures thereof.

In a specific embodiment, exclusively acrylic acid is used as monomer A).

The monomer A) is used preferably in an amount of from 50 to 100% by weight, particularly preferably 60 to 100% by weight, based on the total weight of the monomer composition M).

In a preferred embodiment, the monomer composition M) consists to at least 50% by weight, preferably to at least 80% by weight, in particular to at least 90% by weight, based on the total weight of the monomer composition M), of acrylic acid and/or acrylic acid salts.

### Monomer B)

The monomer composition M) can comprise, in addition to the monomers A), at least one monomer B) which is selected from unsaturated sulfonic acids, salts of unsaturated sulfonic acids, unsaturated phosphonic acid, salts of unsaturated phosphonic acids and mixtures thereof.

The monomer B) is preferably selected from 2-acrylamido-2-methylpropanesulfonic acid, vinylsulfonic acid, allylsulfonic acid, sulfoethyl acrylate, sulfoethyl methacrylate, sulfopropyl acrylate, sulfopropyl methacrylate, 2-hydroxy-3-acryloxypropylsulfonic acid, 2-hydroxy-3-methacryloxypropylsulfonic acid, styrenesulfonic acid, vinylphosphonic acid, allylphosphonic acid, salts of the aforementioned acids, and mixtures thereof.

2-Acrylamido-2-methylpropanesulfonic acid is preferred as monomer B).

Suitable salts of the aforementioned acids are in particular the sodium, potassium and ammonium salts, and the salts with amines. The monomers B) can be used as such or as mixtures with one another. The stated weight fractions all refer to the acid form.

Preferably, the monomer composition M) then consists to at least 50% by weight, particularly preferably to at least 80% by weight, in particular to at least 90% by weight, based on the total weight of the monomer composition M), of monomers A) and B). If the monomer composition M) comprises at least one monomer B), then this is used preferably in an amount of from 0.1 to 50% by weight, particularly preferably 1 to 25% by weight, based on the total weight of the monomer composition M).

### Further Monomers C

The monomer composition M) can additionally comprise at least one further monomer different from the monomers containing acid groups and salts thereof.

Preferably, the monomer composition M) additionally comprises at least one comonomer C) selected from
C1) nitrogen heterocycles with a free-radically polymerizable α,β-ethylenically unsaturated double bond,
C2) monomers containing amide groups,
C3) compounds of the general formulae (I.a) and (I.b)

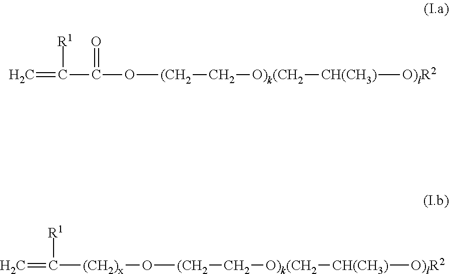

in which
the order of the alkylene oxide units is arbitrary,
x is 0, 1 or 2,
k and l, independently of one another, are an integer from 0 to 100, where the sum of k and l is at least 2, preferably at least 5,
R¹ is hydrogen or methyl,
R² is hydrogen, C₁-C₄-alkyl,
   and mixtures of two or more than two of the aforementioned monomers C1) to C3).

The monomer composition M) can comprise the further monomers C1) to C3) in each case preferably in an amount of from 0 to 30% by weight, particularly preferably 0 to 20% by weight, in particular 0 to 10% by weight, based on the total weight of the monomer composition M). If the monomer composition M) comprises at least one monomer selected from C1) to C3), then in each case preferably in an amount of from 0.1 to 30% by weight, particularly preferably 1 to 20% by weight, in particular 1.5 to 10% by weight, based on the total weight of the monomer composition M). In a specific embodiment, the monomer composition M) comprises no further comonomers apart from the monomers A).

### Monomer C1)

Preferred nitrogen heterocycles with a free-radically polymerizable α,β-ethylenically unsaturated double bond C1) are selected from 1-vinylimidazole (N-vinylimidazole), vinyl- and allyl-substituted nitrogen heterocycles different from 1-vinylimidazole, and mixtures thereof.

From the amine nitrogens of the aforementioned compounds it is possible to generate charged cationic groups either by protonation with acids or by quaternization with alkylating agents. Suitable monomers C1) are also the compounds obtained by protonation or quaternization of 1-vinylimidazole and vinyl- and allyl-substituted nitrogen heterocycles different therefrom. Acids suitable for the protonation are e.g. carboxylic acids, such as lactic acid, or mineral acids, such as phosphoric acid, sulfuric acid and hydrochloric acid. Alkylating agents suitable for the quaternization are C₁-C₄-alkyl halides or di(C₁-C₄-alkyl) sulfates, such as ethyl chloride, ethyl bromide, methyl chloride, methyl bromide, dimethyl sulfate and diethyl sulfate. A protonation or quaternization can generally take place either before or after the polymerization. Preferably, a protonation or quaternization takes place after the polymerization. Examples of such charged monomers C1) are quaternized vinylimidazoles, in particular 3-methyl-1-vinylimidazolium chloride, methosulfate and ethosulfate.

Preferred monomers C1) are furthermore vinyl- and allyl-substituted nitrogen heterocycles different from vinylimidazoles selected from 2-vinylpyridine, 4-vinylpyridine, 2-allylpyridine, 4-allylpyridine and the salts thereof obtained by protonation or by quaternization.

In particular, the monomer composition M) comprises at least one comonomer C1) selected from 1-vinylimidazole, 2-vinylpyridine, 4-vinylpyridine, 2-allylpyridine, 4-allylpyridine and the salts thereof obtained by protonation or by quaternization. Specifically, the monomer composition M) comprises 1-vinylimidazole as comonomer C1).

### Monomer C2)

Suitable amide-group-containing monomers C2) are compounds of the general formula (II)

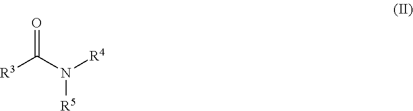

in which
one of the radicals R³ to R⁵ is a group of the formula CH₂═CR⁶— where R⁶=H or C₁-C₄-alkyl and the other radicals R⁶ to R⁸, independently of one another, are H or C₁-C₇-alkyl,
where R³ and R⁴, together with the amide group to which they are bonded, can also be a lactam having 5 to 8 ring atoms,
where R⁴ and R⁵, together with the nitrogen atom to which they are bonded, can also be a five- to seven-membered heterocycle.

Preferably, the monomers C2) are selected from primary amides of α,β-ethylenically unsaturated monocarboxylic acids, N-vinylamides of saturated monocarboxylic acids, N-vinyllactams, N-alkyl- and N,N-dialkylamides, α,β-ethylenically unsaturated monocarboxylic acids and mixtures thereof.

Preferred monomers C2) are N-vinyllactams and derivatives thereof, which can have, e.g., one or more C₁-C₆-alkyl substituents, such as methyl, ethyl, n-propyl, isopropyl, n-butyl, sec-butyl, tert-butyl, etc. These include, e.g., N-vinylpyrrolidone, N-vinylpiperidone, N-vinylcaprolactam, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam and N-vinyl-7-ethyl-2-caprolactam.

Particular preference is given to using N-vinylpyrrolidone and/or N-vinylcaprolactam.

Suitable monomers C2) are furthermore acrylamide and methacrylamide.

N-Alkyl- and N,N-dialkylamides of α,β-ethylenically unsaturated monocarboxylic acids suitable as monomers C2) are, for example, methyl(meth)acrylamide, methylethacrylamide, ethyl(meth)acrylamide, ethylethacrylamide, n-propyl(meth)acrylamide, isopropyl(meth)acrylamide, n-butyl(meth)acrylamide, tert-butyl(meth)acrylamide, tert-butylethacrylamide, and mixtures thereof.

Open-chain N-vinylamide compounds suitable as monomers C2) are, for example, N-vinylformamide, N-vinyl-N-methylformamide, N-vinylacetamide, N-vinyl-N-methylacetamide, N-vinyl-N-ethylacetamide, N-vinylpropionamide, N-vinyl-N-methylpropionamide, N-vinylbutyramide and mixtures thereof. Preference is given to using N-vinylformamide.

Ether-group-containing monomer C3)

The monomer composition M) can additionally comprise at least one monomer C3) selected from compounds of the general formulae (I.a) and (I.b), as defined above.

In the formulae I.a) and I.b), k is preferably an integer from 1 to 100, particularly preferably 2 to 50, in particular 3 to 30. Preferably, l is an integer from 0 to 50.

Preferably, R² in the formulae I.a) and I.b) is hydrogen, methyl, ethyl, n-propyl, isopropyl, n-butyl, sec-butyl or tert-butyl.

In the formula I.b), x is preferably 1 or 2.

Preferably, the polymer P1) comprises less than 15% by weight, preferably less than 10% by weight, polymerized units of monomers different from monomers A).

The polymer P1) is essentially uncrosslinked. The monomer composition M) used for producing the polymer P1) thus comprises in particular no added crosslinking monomers. In the context of the invention, crosslinking monomers are compounds with two or more than two polymerizable ethylenically unsaturated double bonds per molecule.

Specifically, the monomer composition M) comprises, based on the total weight, less than 0.5% by weight, even more specifically less than 0.1% by weight, of crosslinking monomers which have two or more than two free-radically polymerizable α,β-ethylenically unsaturated double bonds per molecule.

In a preferred embodiment, the monomer composition M) comprises no crosslinking monomers having two or more than two polymerizable α,β-ethylenically unsaturated double bonds per molecule.

The polymer P1) can be prepared by free-radical polymerization of a monomer composition M). It is possible to work by any known free-radical polymerization process. In addition to polymerization in bulk, mention should be made especially of the processes of solution polymerization and emulsion polymerization, preference being given to solution polymerization.

As regards the monomer composition M) used for the preparation of P1), reference is made to the aforementioned suitable and preferred monomers in their entirety.

The polymerization is preferably performed in water as a solvent. However, it can also be undertaken in alcoholic solvents, especially C₁-C₄-alcohols, such as methanol, ethanol and isopropanol, or mixtures of these solvents with water.

The free-radical polymerization of the monomer composition M) is preferably carried out in the feed procedure. Here, in general at least the monomers are metered into the reaction mixture in liquid form. Monomers that are liquid under the addition conditions can be introduced into the reaction mixture without adding a solvent. Otherwise the monomers are used as solution in a suitable solvent.

Suitable polymerization initiators are compounds which decompose thermally, by a redox mechanism or photochemically (photo initiators) to form free radicals.

Among the polymerization initiators that can be thermally activated, preference is given to initiators having a decomposition temperature in the range from 20 to 180° C., especially from 50 to 90° C. Examples of suitable thermal initiators are inorganic peroxo compounds such as peroxodisulfates (ammonium peroxodisulfate and preferably sodium peroxodisulfate), peroxosulfates, percarbonates and hydrogen peroxide; organic peroxo compounds such as diacetyl peroxide, di-tert-butyl peroxide, diamyl peroxide, 5-dioctanoyl peroxide, didecanoyl peroxide, dilauroyl peroxide, dibenzoyl peroxide, tert-butyl perneodecanoate, tert-butyl perbenzoate, tert-butyl perisobutyrate, tert-butyl perpivalate, tert-butyl peroctoate, tert-butyl peroxide, tert-butyl hydroperoxide, cumene hydroperoxide, tert-butylperoxy-2-ethylhexanoate and 10-diisopropyl peroxydicarbamate; azo compounds such as 2,2′-azobisisobutyronitrile, 2,2′-azobis(2-methylbutyronitrile) and azobis(2-amidopropane) dihydrochloride.

These initiators can be used in combination with reducing compounds as initiator/regulator systems. Examples of such reducing compounds include phosphorus compounds such as phosphorous acid, hypophosphites and phosphinates, sulfur compounds such as sodium hydrogensulfite, sodium sulfite and sodium formaldehyde-sulfoxylate, and hydrazine.

Also frequently used are redox initiator systems which consist of a peroxo compound, a metal salt and a reducing agent. Examples of suitable peroxo compounds are hydrogen peroxide, peroxodisulfate (as the ammonium, sodium or potassium salt), peroxosulfates, and organic peroxo compounds such as tert-butyl hydroperoxide, cumene hydroperoxide or dibenzoyl peroxide. Suitable metal salts are in particular iron(II) salts such as iron(II) sulfate heptahydrate. Suitable reducing agents are sodium sulfite, the disodium salt of 2-hydroxy-2-sulfinatoacetic acid, the disodium salt of 2-hydroxy-2-sulfonatoacetic acid, sodium hydroxymethanesulfinate, ascorbic acid, isoascorbic acid or mixtures thereof.

Examples of suitable photoinitiators are benzophenone, acetophenone, benzyl dialkyl ketones and derivatives thereof.

Preference is given to using thermal initiators, preferably inorganic peroxo compounds, especially sodium peroxodisulfate. The peroxo compounds are advantageously used in combination with sulfur-containing reducing agents, especially sodium hydrogensulfite, as the redox initiator system. In the case of use of this initiator/regulator system, copolymers comprising sulfonate and/or sulfate as end groups are obtained, which are notable for exceptional cleaning power and scale-inhibiting action.

Alternatively, it is also possible to use phosphorus-containing regulator systems, for example sodium hypophosphite and phosphinates.

The amounts of initiator/regulator system should be matched to the substances used in each case. If, for example, the peroxodisulfate/hydrogensulfite system is used, typically 1 to 7% by weight, preferably 2 to 6% by weight, of peroxodisulfate and generally 3 to 25% by weight, preferably 4 to 15% by weight, of hydrogensulfite are used, based in each case on monomer composition M).

If desired, it is also possible to use organic polymerization regulators. Suitable examples are sulfur compounds such as mercaptoethanol, 2-ethylhexyl thioglycolate, thioglycolic acid and dodecyl mercaptan. When polymerization regulators are used, the amount thereof is generally 0.1 to 25% by weight, preferably 0.5 to 20% by weight and more preferably 1.0 to 15% by weight, based in each case on monomer composition M).

The polymerization temperature is generally 20 to 200° C., preferably 20 to 150° C. and more preferably 20 to 120° C.

The polymerization can be performed under atmospheric pressure, but is preferably undertaken in a closed system under the autogenous pressure which evolves.

The polymerization can take place in the absence or in the presence of an inert gas. Usually, the polymerization is carried out in the presence of an inert gas, e.g. nitrogen.

The weight-average molecular weight M_{w} of the polymer P1) can be determined by means of gel permeation chromatography (GPC) in aqueous solution using neutralized polyacrylic acid as polymer standard. The polymer P1) preferably has a weight-average molecular weight of from 1000 to 100 000 g/mol, more preferably 1 500 to 50 000 g/mol, in particular 2 000 to 20 000 g/mol.

Preferably, polymer P1) has a polydispersity index (PDI) of from 1.2 to 6.0, more preferably 1.4 to 4.0, in particular 1.6 to 3.5.

The polymer P1) can be obtained in the acidic state, but it can also, if desired be partly neutralized by addition of bases. Suitable bases are alkali metal hydroxides, like NaOH and KOH, alkaline earth metal hydroxides, like Ca(OH)₂ and Mg(OH)₂, ammonia and amine bases, like monoethanol amine. Especially preferred is sodium hydroxide. Neutralization can be performed as early as during the polymerization or after the polymerization has ended.

Prior to its use in step a) for providing the aqueous composition, at the most 30 mol % of the carboxy groups of the polymer P1) are in the deprotonated form. Preferably, at the most 25 mol %, more preferably at the most 15 mol %, of the carboxy groups of the polymer P1) are in the deprotonated form. In a special embodiment, the acid groups of the polymer composition according to the invention are present in non-neutralized form.

The polymer P1) used in accordance with the invention can be used directly in the form of the aqueous solutions obtained in the course of preparation by means of solvent polymerization, or in dried form (obtained, for example, by spray drying, spray granulation such as fluid bed spray granulation or spouted bed spray granulation, roller drying or freeze drying).

Suitable polymers P1) are commercially available or are intermediates of commercially available products. In a preferred embodiment, a commercially available polyacrylic acid is employed that is not crosslinked and not neutralized or only to a low extend neutralized. Suitable products are Sokalan® CP 10 S, Sokalan® CP 12 S, Sokalan® CP 13 S, Sokalan® PA 25 XS, Sokalan® PA 80 S and Sokalan® NR 2530 from BASF SE.

### Ethers of Polyoxyalkylene Glycols PE)

Suitable components PE) are selected from monoalkyl ethers, dialkyl ethers, mono-(hydroxyalkyl) ethers and di(hydroxyalkyl) ethers of polyoxyalkylene glycols.

Suitable ethers of polyoxyalkylene glycols PE) have a number-average molecular weight in the range from about 200 to 2000, preferably 250 to 1500.

The stated degrees of alkoxylation, specifically degrees of ethoxylation, are statistical averages (number-average, Mn) which can be an integer or a fraction for a specific product. Preferred alcohol ethoxylates have a narrowed homolog distribution (narrow range ethoxylates, NRE).

Suitable alkylene oxides for producing the ethers of polyoxyalkylene glycols PE) are e.g. ethylene oxide, propylene oxide, epichlorohydrin, 1,2- and 2,3-butylene oxide.

Suitable polyoxyalkylene ether groups are, for example, homopolymers of ethylene oxide, homopolymers of propylene oxide, copolymers of ethylene oxide and propylene oxide, copolymers of ethylene oxide and butylene oxide, and copolymers of ethylene oxide, propylene oxide and at least one butylene oxide. The polyoxyalkylene ether groups which comprise various alkylene oxides in copolymerized form can comprise the alkylene oxide units in random distribution or in the form of blocks. A specific embodiment is a polyoxyalkylene ether group which comprises ethylene oxide and propylene oxide in copolymerized form. Preferably, in the ethylene oxide/propylene oxide copolymers, the fraction of repeat units derived from ethylene oxide is 40 to 99% by weight. Particular preference is given to ethers of polyoxyalkylene glycols PE) whose polyoxyalkylene ether group comprises exclusively ethylene oxide repeat units.

In a first preferred embodiment, the polyoxyalkylene ethers PE) are compounds of the general formula (III.1)

R⁷O—(R⁸O)ₛR⁹ (III.1)

in which
R⁷ is C₈-C₁₈-alkyl,
R⁸ is selected in the repeat units (R⁸O) in each case independently of one another from

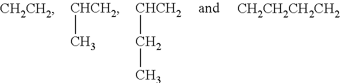

R⁹ is hydrogen or C₁-C₄-alkyl, and
s is an integer from 3 to 25.

In the following, the compounds of the formula (III.1) are also denoted as (C₈-C₁₈-alkyl)polyoxyalkylene ethers.

The C₈-C₁₈-alkyl radicals of the (C₈-C₁₈-alkyl)polyoxyalkylene ethers PE) can be derived from the corresponding alcohols, specifically alcohols of the general formula R⁷—OH by formal elimination of the OH group. The C₈-C₁₈-alkyl radicals of the (C₈-C₁₈-alkyl)polyoxyalkylene ethers PE) can be derived from pure alcohols or from alcohol mixtures. Preferably, they are industrially available alcohols or alcohol mixtures.

The C₈-C₁₈-alkyl radicals of the (C₈-C₁₈-alkyl)polyoxyalkylene ethers (PE) used according to the invention or the alcohols R⁷—OH used for their production can also originate from a renewable, natural and/or sustainable source. In the context of the invention, renewable sources are understood as meaning natural (biogenic) and/or sustainable sources and not fossil sources, such as petroleum, natural gas or coal.

Preferred (C₈-C₁₈-alkyl)polyoxyalkylene ethers generally have a number-average molecular weight in the range from about 260 to 1000, preferably 300 to 800.

Suitable (C₈-C₁₈-alkyl)polyoxyalkylene ethers are water-soluble nonionic polymers which have alkylene oxide repeat units.

The C₈-C₁₈-alkyl radicals of the (C₈-C₁₈-alkyl)polyoxyalkylene ethers (PE) used according to the invention or the radicals R⁷ can be derived from alcohols and alcohol mixtures of native or petrochemical origin having 8 to 18 carbon atoms. The (C₈-C₁₈-alkyl) radicals or the radicals R⁷ can be derived from primary, secondary, tertiary or quaternary alcohols. Preferably, the (C₈-C₁₈-alkyl) radicals and/or the radicals R⁷ are derived from primary alcohols. The (C₈-C₁₈-alkyl) radicals of the (C₈-C₁₈-alkyl)polyoxyalkylene ethers or the radicals R⁷ can furthermore be straight-chain or branched. Preferably, the (C₈-C₁₈-alkyl) radicals or the radicals R⁷ are linear or predominantly linear alkyl radicals. Predominantly linear alkyl radicals are understood as meaning those which have essentially methyl group branches and essentially no longer-chain branches. In a first preferred embodiment, the (C₈-C₁₈-alkyl) radicals are linear alkyl radicals. In a second preferred embodiment, the (C₈-C₁₈-alkyl) radicals are predominantly linear alkyl radicals, as also occur in natural or synthetic fatty acids and fatty alcohols, and oxo alcohols. Specifically, the (C₈-C₁₈-alkyl) radicals can be linear or preferably 2-methyl-branched and/or comprise linear and methyl-branched radicals in a mixture, as are customarily present in oxo alcohol radicals. In a further preferred embodiment, the (C₈-C₁₈-alkyl) radicals are branched alkyl radicals as they have longer-chain alcohols which are obtained by Guerbet condensation. During the Guerbet condensation, primary or secondary alcohols are condensed at high temperatures and high pressure in the presence of alkali metal hydroxides or alkoxides to give longer-chain alcohols, which are also called Guerbet alcohols. A suitable Guerbet alcohol is a C₁₆-C₂₀-alcohol that is n-butyl-terminated and alkoxylated with 7 to 8 ethylene oxide groups per molecule.

The C₈-C₁₈-alkyl radicals of the (C₈-C₁₈-alkyl)polyoxyalkylene ethers (PE) are preferably C₁₂-C₁₈-alkyl radicals, for example C₉-C₁₆-alkyl radicals or C₁₀-C₁₄-alkyl radicals. In the compounds of the general formula (III), R⁷ is preferably C₁₂-C₁₈-alkyl, such as C₉-C₁₆-alkyl or C₁₀-C₁₄-alkyl.

Suitable are (C₈-C₁₈-alkyl)polyoxyalkylene ethers which are derived from a single alcohol having 12 to 18 carbon atoms, for example having 9 to 16 carbon atoms or having 10 to 14 carbon atoms. These include, for example, coconut, palm, tallow fatty or oleyl alcohol.

Suitable are also (C₈-C₁₈-alkyl)polyoxyalkylene ethers which are derived from alcohol mixtures, e.g. selected from C₁₂C₁₄-alcohols, C₉C₁₁-alcohols, C₁₃C₁₅-alcohols, C₁₂C₁₈-alcohols and C₁₂C₁₄-alcohols.

The (C₈-C₁₈-alkyl)polyoxyalkylene ethers comprise in the polyoxyalkylene ether group preferably on average 3 to 12, more preferably 3 to 10, particularly preferably 5 to 9, alkylene oxide units, per mole of alcohol. In the compounds of the general formula (III.1), s is preferably 3 to 12, more preferably 3 to 10, in particular 5 to 9.

Suitable alkylene oxides for producing the (C₈-C₁₈-alkyl)polyoxyalkylene ethers are e.g. ethylene oxide, propylene oxide, epichlorohydrin, 1,2- and 2,3-butylene oxide. Preferred polyoxyalkylene ether groups of the compound (III.1) are, for example, homopolymers of ethylene oxide, homopolymers of propylene oxide and copolymers of ethylene oxide and propylene oxide. As mentioned before, the polyoxyalkylene ether groups which comprise various alkylene oxides in copolymerized form can comprise the alkylene oxide units in random distribution or in the form of blocks. Particular preference is given to (C₈-C₁₈-alkyl)polyoxyalkylene ethers whose polyoxyalkylene ether group comprises exclusively ethylene oxide repeat units.

Preferably, the polyether groups of the (C₈-C₁₈-alkyl)polyoxyalkylene ethers PE) carry a hydrogen atom at the non-C₈-C₁₈-alkyl-terminated ends or are terminated with a C₁-C₄-alkyl group (i.e. terminally capped). In the compounds of the general formula (III.1), R⁹ is accordingly H or C₁-C₄-alkyl. Preferably, R⁹ is H or methyl. In a particularly preferred embodiment, the polyether groups on the non-C₈-C₁₈-alkyl-terminated ends carry a hydrogen atom, i.e. R⁹ is particularly preferably H.

The (C₈-C₁₈-alkyl)polyoxyalkylene ethers PE) are preferably alkoxylated, advantageously ethoxylated, primary alcohols having preferably 8 to 18 carbon atoms and on average 3 to 12, preferably 3 to 10, particularly preferably 5 to 9, mole of ethylene oxide (EO) per mole of alcohol, in which the alcohol radical can be linear or preferably 2-methyl-branched and/or can comprise linear and methyl-branched radicals in a mixture, as are customarily present in oxo alcohol radicals.

The (C₈-C₁₈-alkyl)polyoxyalkylene ethers PE) are preferably selected from:
C₁₂C₁₄-fatty alcohols with 3 EO, 5 EO, 7 EO or 9 EO,
C₉C₁₁-oxo alcohols with 7 EO,
C₁₃-oxo alcohol with 3 EO, 5 EO, 7 EO or 9 EO,
C₁₃C₁₅-oxo alcohols with 3 EO, 5 EO, 7 EO or 9 EO,
C₁₂C₁₈-fatty alcohols with 3 EO, 5 EO, 7 EO or 9 EO and mixtures thereof,
2-propylheptanol with 3 EO, 4 EO, 5 EO, 6 EO, 7 EO, 8 EO and 9 EO and mixtures of two or more than two of the aforementioned ethoxylated alcohols.

Preferred mixtures of ethoxylated alcohols are mixtures of C₁₂C₁₄-alcohol with 3 EO and C₁₂C₁₈-alcohol with 7 EO. Preferred mixtures of ethoxylated alcohols are also mixtures of short-chain alcohol ethoxylates (e.g. 2-propylheptanol with 7 EO) and long-chain alcohol ethoxylates (e.g. C₁₆C₁₈-alcohols with 7 EO).

Suitable components PE) are also mono(hydroxyalkyl) ethers and di(hydroxyalkyl) ethers of polyoxyalkylene glycols.

Depending on the length of the alkyl chain, each hydroxyalkyl group may bear 1, 2, 3 or more than 3 OH groups. Preferably, the components PE) are selected from mono(hydroxyalkyl) ethers of polyoxyalkylene glycols, and di(hydroxyalkyl) ethers of polyoxyalkylene glycols, wherein both hydroxyalkyl groups bears only 1 OH.

In a second preferred embodiment, the polyoxyalkylene ethers PE) are compounds of the general formula (III.2)

R⁷O—(R⁸O)ₛR⁹ (III.2)

in which
R⁷ is C₈-C₁₈-alkyl,
R⁸ is selected in the repeat units (R⁸O) in each case independently of one another from

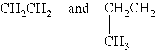

R⁹ is C₈-C₁₈-hydroxyalkyl, and
s is an integer from 3 to 25.

In the compounds of the general formula (III.2), s is preferably an integer of 3 to 12.

Preferred are compounds of the formula: (C₈₋₁₈-alkyl)-CH(OH)CH₂O-(EO)₂₋₂₄-(C₈₋₁₈-alkyl)

### Production of the Polymer Films

A further object of the invention is a process for producing a washing- and cleaning-active polymer film, comprising
a) providing an aqueous composition by mixing
   a polymer P1) that comprises polymerized units of at least one monomer A), selected from α,β-ethylenically unsaturated carboxylic acids, salts of α,β-ethylenically unsaturated carboxylic acids and mixtures thereof,
   an polyoxyalkylene ether PE) having at least one C₈-C₁₈-alkyl group that is unsubstituted or substituted by at least one hydroxyl group, and an average of 3 to 25 alkylene oxide units per molecule, and
   water,
   wherein at the most 30 mol % of the carboxy groups of the polymer P1) are in the deprotonated form,
   the weight ratio of the polymer P1) to the polyoxyalkylene ether PE) is in a range from 0.9:1 to 5:1, and
   the aqueous composition has a water content of at least 10% by weight and at most 50% by weight, based on the total weight of the aqueous composition, and
b) converting the aqueous composition to a polymer film.

Preferably, the weight ratio of the polymer P1) to the polyoxyalkylene ether PE) is in a range from 0.9:1 to 4:1, more preferably 1:1 to 3:1.

Preferably, the aqueous composition has a water content of at least 15% by weight, more preferably at least 20% by weight, based on the total weight of the aqueous composition. Preferably, the aqueous composition has a water content of at most 50% by weight, based on the total weight of the aqueous composition.

### Step a):

In step a) of the process one or more mixers may be used to provide the aqueous composition. If more than one mixer is used, these may be mixers of identical or different design, which are used in any desired sequence, arrangement and combination, for example an arrangement of all mixers in series, a combination of a parallel and series arrangement or a parallel arrangement of all mixers. If a plurality of mixers is used, the series arrangement is preferred.

Suitable mixers are in particular dynamic mixers whose mixing elements contain movable parts and static mixers, i.e. mixing elements without moving parts in the interior.

Mixers can be applied in a continuous manner as continuous mixers, whereby all components are continuously fed to the mixer and the obtained mixture or partial mixture is continuously discharged, in a discontinuous (batch wise) manner, whereby all components are added to the mixer in advance and the obtained mixture is discharged at least partially after the mixing operation is at least partially finished, or in a semibatch manner, whereby optionally at least one of the components is at least partially added in advance, while at least one of the components is at least partially dosed to the mixer and the obtained mixture is discharged at least partially, when the missing operation is at least partially finished.

Suitable mixers are in particular dispersing machines, stirred tanks, kneaders, extruders, dynamic mixers, static mixers, rotating mixers, and mills.

Suitable dispersing machines are machines of the rotor stator type, the rotating dispersion disc type, the dual asymmetric centrifuge type (Speedmixer), and all other common dispersing machines.

Suitable stirred tank reactors are equipped with at least one moving mixing element, such as a stirrer. Common stirrer types comprise, for example, propeller stirrers, impeller stirrers, disk stirrers, paddle stirrers, anchor stirrers, oblique blade stirrers, crossbeam stirrers, helical ribbon impellers, screw-type stirrers, etc.

Kneaders are available in various designs. The general shape of the kneader can preferably be conical or cylindrical or a combination of both geometries. Common kneaders comprise single shaft and twin shaft designs, but also the utilization of three or more shafts is possible. Usually, conveying elements or mixing elements, or preferably a combination of both are aligned along the shafts. The shafts can be rotated continuously, oscillated or moved in a combination of rotation and oscillation. In case of multiple shafts, these can be aligned in parallel or in a defined angle. Kneaders for continuous service may comprise special zones for physical operations, such as cooling, heating, degassing, evaporation of volatiles etc.

Suitable rotating mixers are e.g. planetary mixers and double planetary mixers.

Mixers can next to mixing also be used to fulfill other purposes, such as cooling, heating, degassing, evaporation of water and optionally other components.

Preferably, in step a) the mixing is performed at temperature in the range from 0 to 100° C., more preferably 20 to 95° C., in particular 30 to 90° C.

Usually, the mixing in step a) takes place over a period of 1 minutes to 48 hours, preferably 1.5 minutes to 24 hours.

In a suitable embodiment, mixing is performed batch-wise in a kettle as mixing apparatus. In a first variant of this embodiment the components to be mixed for providing the aqueous composition, i.e. the polymer P1), the polyoxyalkylene ether PE) and water are initially completely fed to the kettle and then subjected to the mixing operation. In a further variant of this embodiment at least one of the components is added to the kettle in one or more than one portion to the mixing operation. Preferably, the initial feed comprises at least a part of the water used for providing the aqueous composition. More preferably, the initial feed comprises the complete amount of the water used for providing the aqueous composition.

In another suitable embodiment, mixing is performed batch-wise in a dual asymmetric centrifuge (Hauschild™ Speedmixer). Then, the temperature is preferably in a range of from 0 to 100° C., more preferably 20 to 70° C., especially 40 to 75° C. The rotation speed is preferably in a range of from 100 to 3500 rpm, more preferably 1000 to 2500 rpm. Preferably mixing takes place over a period of 0.2 to 10 minutes, more preferably 1 to 5 minutes.

In another suitable embodiment, mixing is performed batch-wise or semibatch-wise in a kneader. In a special embodiment a Duplex kneader is employed. The rotation speed is preferably in a range of from 10 to 500 rpm, more preferably 20 to 100 rpm. The temperature is preferably in a range of from 0 to 100° C., more preferably 20 to 70° C., especially 40 to 75° C. Preferably mixing takes place over a period of 2 min to 5 hours, more preferably 10 min to 120 min.

It is possible to add additives to the aqueous composition prior to and/or during and/or after mixing step a). Suitable additives are those used for the formation of polymer films, like plasticizers, scavengers, agents for modification of gas permeability and water vapor permeability, antistats, glidants, slip agents, UV absorbers, etc. Suitable additives are also those mentioned in the following for the detergent and cleaner formulations. In a special embodiment at least one enzyme is used as additive. Reference is made to those mentioned in the following as component E1) of the detergent and cleaner formulations.

### Step b): Film Formation

In step b) of the process according to the invention, the aqueous composition obtained in step a) is converted to a polymer film.

The process of the invention allows the formation of single layer films and of multilayer films. In principle, for the formation of a single layer film, the aqueous composition obtained in step a), comprising a polymer P1), a polyoxyalkylene ether PE), water and optionally at least one additive, is subjected to a film formation. The film formation preferably takes place by casting, blow molding, thermoforming or calendering.

Multilayer films consist preferably of 2 to 20 layers, more preferably 2 to 15 layers and especially 2 to 10 layers. These specifically include multilayer films consisting of 2, 3, 4, 5, 6, 7 or 8 layers. All these layers may be of different composition, or two or more than two of the layers may have the same composition. The composition of the individual layers depends on the field of use of the multilayer film.

The multilayer film comprises at least one layer comprising or consisting of a mixture of at least one polymer P1) and at least one polyoxyalkylene ether PE). Preferably, the multilayer film comprises at least one further layer comprising or consisting of at least one polymer P2) other than the polymers P1). Suitable polymers P2) are defined in detail in the following.

In a preferred embodiment, the individual layers of the multilayer films are water-soluble or water-dispersible. According to the field of use of the multilayer films, it may be advantageous for the individual layers to have a particular solubility in water. For example, it may be desirable for different layers to have different solubility in water. It may also be desirable, for example, for an outer surface layer to have a lesser degree of water solubility in order to prevent blocking and/or partial dissolution in the event of high air humidity and/or high contact moisture (e.g. hand moisture). Alternatively, it may also be desirable for an outer surface layer to have sufficient water solubility in order to timely release an active ingredient present therein or ensheathed therewith on contact with water.

According to the field of use of the multilayer films, it may also be advantageous for the individual layers to have a temperature-dependent solubility in water.

The multilayer film of the invention preferably comprises at least one further layer comprising or consisting of at least one polymer P2) selected from
natural and modified polysaccharides,
homo- and copolymers comprising repeat units which derive from vinyl alcohol, vinyl esters, alkoxylated vinyl alcohols or mixtures thereof,
homo- and copolymers comprising at least one copolymerized monomer selected from N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof,
homo- and copolymers of acrylic acid and/or methacrylic acid, especially copolymers comprising at least one copolymerized acrylic monomer selected from acrylic acid, acrylic salts and mixtures thereof, and at least one copolymerized maleic monomer selected from maleic acid, maleic anhydride, maleic salts and mixtures thereof,
copolymers comprising at least one copolymerized (meth)acrylic monomer selected from acrylic acid, methacrylic acid, salts thereof and mixtures thereof and at least one copolymerized hydrophobic monomer selected from C₁-C₈-alkyl esters of (meth)acrylic acid, C₂-C₁₀ olefins, styrene and α-methylstyrene,
copolymers comprising at least one copolymerized maleic monomer selected from maleic acid, maleic anhydride, maleic salts and mixtures thereof and at least one copolymerized C₂-C₈ olefin,
homo- and copolymers comprising at least one monomer comprising sulfonic acid groups,
homo- and copolymers of acrylamide and/or methacrylamide,
polyamino acids,
water-soluble or water-dispersible polyamides,
polyalkylene glycols, mono- or diethers of polyalkylene glycols, and
mixtures thereof.

The multilayer film more preferably comprises at least one further layer comprising or consisting of at least one polymer P2) selected from
cellulose ethers and cellulose esters,
homo- and copolymers comprising repeat units which derive from vinyl alcohol, vinyl esters, alkoxylated vinyl alcohols or mixtures thereof,
polymers selected from polyvinylpyrrolidone homopolymers, polyvinylimidazole homopolymers, copolymers comprising copolymerized vinylpyrrolidone and vinylimidazole, polyvinylpyridine N-oxide, poly-N-carboxymethyl-4-vinylpyridium halides,
mixtures thereof.

The multilayer film especially comprises at least one further layer comprising or consisting of at least one polymer P2) selected from cellulose derivatives, preferably carboxyalkyl celluloses and salts thereof, sulfoalkyl celluloses and salts thereof, acidic sulfuric ester salts of cellulose, alkyl celluloses, hydroxyalkyl celluloses, hydroxyalkyl alkyl celluloses and mixtures of two or more of these cellulose derivatives.

Polysaccharides suitable as polymers P2) are natural polysaccharides, for example cellulose, hemicellulose, xyloglucan, glycogen, starch (amylose and amylopectin), dextran, pectins, inulin, xanthan, chitin, callose, etc. and thermally, hydrolytically or enzymatically degraded natural polysaccharides, for example maltodextrin etc.

Preferred modified polysaccharides are, for example, cellulose ethers, cellulose esters, cellulose amides, etc.

Cellulose ethers are derivatives of cellulose which arise through partial or complete substitution of the hydrogen atoms in the hydroxyl groups of the cellulose. Cellulose ethers from the reaction of cellulose with more than one etherifying agent are also referred to as cellulose mixed ethers.

Preferred cellulose ethers are selected from alkyl celluloses, hydroxyalkyl celluloses, hydroxyalkyl alkyl celluloses, carboxyalkyl celluloses and salts thereof, carboxyalkyl alkyl celluloses and salts thereof, carboxyalkyl hydroxyalkyl celluloses and salts thereof, carboxyalkyl hydroxyalkyl alkyl celluloses and salts, sulfoalkyl celluloses and salts thereof.

Preferred carboxyalkyl radicals are the carboxymethyl radical and the carboxyethyl radical. A particularly preferred carboxyalkyl radical is the carboxymethyl radical. Preferred sulfoalkyl radicals are the sulfomethyl radical and the sulfoethyl radical. A particularly preferred sulfoalkyl radical is the sulfomethyl radical. Preferred salts are the sodium, potassium, calcium and ammonium salts.

Particularly preferred cellulose ethers are selected from carboxymethyl cellulose, carboxyethyl cellulose, methyl cellulose, ethyl cellulose, n-propyl cellulose, ethyl methyl cellulose, hydroxyethyl cellulose, hydroxypropyl cellulose, hydroxybutyl cellulose, hydroxyethyl methyl cellulose, hydroxypropyl methyl cellulose, hydroxyethyl ethyl cellulose, hydroxypropyl ethyl cellulose, carboxymethyl methyl cellulose, carboxymethyl ethyl cellulose, carboxymethyl hydroxyethyl cellulose, carboxymethyl hydroxyethyl methyl cellulose, carboxymethyl hydroxyethyl ethyl cellulose, sulfomethyl cellulose and sulfoethyl cellulose. The carboxyalkyl radicals and the sulfoalkyl radicals may also be in salt form.

Cellulose esters are derivatives of cellulose which form as a result of esterification of the hydroxyl groups with acids. Preference is given to the sulfuric esters of cellulose. In a specific embodiment, the sulfuric acid is subjected only to a partial esterification, such that the resulting sulfuric esters still have free acid groups or salts thereof. Particular preference is given to using acidic sulfuric ester salts of cellulose. These are notable for their graying-inhibiting effect.

Preferred modified polysaccharides are selected from methyl cellulose, ethyl cellulose, propyl cellulose, methyl/ethyl cellulose, ethyl/propyl cellulose, carboxymethyl cellulose, salts of carboxymethyl cellulose, hydroxyethyl cellulose, hydroxypropyl cellulose, hydroxyethyl methyl cellulose, hydroxyethyl ethyl cellulose, hydroxypropyl methyl cellulose, hydroxypropyl ethyl cellulose, etc.

In a further preferred embodiment, the polymers P2) are selected from homo- and copolymers comprising repeat units which derive from vinyl alcohol, vinyl esters, alkoxylated vinyl alcohols or mixtures thereof.

Suitable vinyl esters (vinyl acylates) are generally the esters of vinyl alcohol with C1-C15 carboxylic acids, preferably C1-C8 carboxylic acids, more preferably C1-C4 carboxylic acids. Preferred vinyl acylates are vinyl acetate, vinyl n-propionate, vinyl n-butyrate, vinyl 2-ethylhexanoate, vinyl laurate, etc. Particular preference is given to vinyl acetate.

Partly or fully hydrolyzed polyvinyl acetates (PVAs) are generally referred to as “polyvinyl alcohol (PVOH)”. Partly hydrolyzed polyvinyl acetates are obtained by incomplete hydrolysis of polyvinyl acetates, meaning that the partly hydrolyzed polymer has both ester groups and hydroxyl groups. The hydrolysis of the polyvinyl acetates can be effected in a manner known per se under alkaline or acidic conditions, i.e. with addition of acid or base.

The performance properties of polyvinyl alcohols are determined by factors including the polymerization level and the hydrolysis level (level of hydrolysis). With rising hydrolysis level, the water solubility decreases. Polyvinyl alcohols having hydrolysis levels up to about 90 mol % are generally soluble in cold water. Polyvinyl alcohols having hydrolysis levels of about 90 to about 99.9 mol % are generally no longer soluble in cold water but are soluble in hot water.

Polyvinyl alcohols suitable as polymers P2) preferably have a hydrolysis level of 50 to 99.9 mol %, more preferably of 70 to 99 mol %, especially of 80 to 98 mol %.

Polyvinyl alcohols suitable as polymers P2) preferably have a weight-average molecular weight of 10 000 to 300 000 g/mol, more preferably of 15 000 to 250 000 g/mol.

Polyvinyl alcohols suitable as polymers P2) preferably have a viscosity of 2 to 120 mPa s, more preferably of 7 to 70 mPa s and especially of 15 to 60 mPa s, measured to DIN 53015 on a 4% solution in water.

Polyvinylalcohol that can typically be used as polymers P2) are known under the tradename Poval™ from Kuraray company. Non limiting examples are Poval™ 8-88, Poval™ 18-88, Poval™ 26-88, Poval™ 30-92, Poval™ 10-98, Poval™ 20-98 or Poval™ 28-99.

A special embodiment of the polymers P2) are copolymers comprising polyvinylalcohol repeat units and repeat units of at least one anionically modified monomer. Suitable classes of anionically modified monomers comprise monocarboxylic acid vinyl monomers, their esters and anhydrides, dicarboxylic monomers having a polymerizable double bond, their esters and anhydrides, vinyl sulfonic acid monomers, and alkali metal salts of any of the foregoing. Examples of suitable anionically modified monomers are vinyl acetic acid, maleic acid, monoalkyl maleate, dialkyl maleate, monomethyl maleate, dimethyl maleate, maleic anhydride, fumaric acid, monoalkyl fumarate, dialkyl fumarate, (in particular monomethyl fumarate and dimethyl fumarate), fumaric anhydride, itaconic acid, monomethyl itaconate, dimethyl itaconate, itaconic anhydride, vinyl sulfonic acid, allyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, 2-sulfoethyl acrylate, alkali metal salts of the foregoing (e.g., sodium, potassium, or other alkali metal salts), esters of the foregoing (e.g., methyl, ethyl, or other C₁-C₆ alkyl esters), and combinations thereof (e.g., multiple types of anionic monomers or equivalent forms of the same anionic monomer). In a preferred embodiment, the anionically modified monomer is selected from 2-acrylamido-1-methylpropanesulfonic acid, 2-acrylamido-2-methylpropanesulfonic acid, 2-methylacrylamido-2-methylpropanesulfonic acid, itaconic acid, monomethyl itaconate, dimethyl itaconate, itaconic anhydride and the alkali metal salts thereof. The level of incorporation of the one or more anionically modified monomer units in the PVOH copolymers is not particularly limited. In a suitable embodiment, the one or more anionically modified monomer units are present in the PVOH copolymer in an amount in a range of about 2 mol % to about 10 mol %.

To tune the performance properties according to the specific need of the application blends comprising polyvinylalcohols of different molecular weight and degree of hydrolysis can be used. Suitable blends are selected from a blend of at least two different polyvinylalcohol homopolymers, a blend of at least two different polyvinylalcohol copolymers, a blend of at least one polyvinylalcohol homopolymer and at least one polyvinylalcohol copolymer. Suitable polyvinylalcohol copolymers for the blends are those mentioned above.

Non limiting examples of blends of polyvinylalcohol homopolymers are a blend of Poval™ 26-88 (three parts) and Poval™ 20-98 (one part) or a blend of Poval™ 30-92 (two parts) and Poval™ 10-98 (one part).

In a further preferred embodiment, the polymers P2) are selected from homo- and copolymers comprising at least one copolymerized monomer selected from N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof.

N-Vinylimidazole, 2-vinylpyridine and 4-vinylpyridine can be converted to the corresponding salts by protonation or quaternization. Suitable acids are, for example, mineral acids such as sulfuric acid, hydrochloric acid and phosphoric acid, and carboxylic acids. Alkylating agents suitable for quaternization are C₁-C₄-alkyl halides or C₁-C₄-alkyl sulfates, such as ethyl chloride, ethyl bromide, methyl chloride, methyl bromide, dimethyl sulfate and diethyl sulfate.

Preference is given to polyvinylpyrrolidone homopolymers and copolymers comprising copolymerized N-vinylpyrrolidone and another different copolymerized ethylenically unsaturated monomer. Suitable N-vinylpyrrolidone copolymers are quite generally uncharged, anionic, cationic and amphoteric polymers.

Particularly preferred N-vinylpyrrolidone copolymers are selected from copolymers of N-vinylpyrrolidone and vinyl acetate, copolymers of N-vinylpyrrolidone and vinyl propionate, copolymers of N-vinylpyrrolidone, vinyl acetate and vinyl propionate, copolymers of N-vinylpyrrolidone and vinyl acrylate, copolymers of N-vinylpyrrolidone, ethyl methacrylate and methacrylic acid, copolymers of N-vinylpyrrolidone and N-vinylimidazole and the derivatives thereof obtained by protonation and/or quaternization, copolymers of N-vinylpyrrolidone and dimethylaminoethyl methacrylate and the derivatives thereof obtained by protonation and/or quaternization, copolymers of N-vinylpyrrolidone, N-vinylcaprolactam and N-vinylimidazole and the derivatives thereof obtained by protonation and/or quaternization.

In a further preferred embodiment, the polymers P2) are selected from homo- and copolymers of acrylic acid and/or methacrylic acid.

In a first specific embodiment of the homo- and copolymers of acrylic acid and/or methacrylic acid, the polymer P2) used is an acrylic acid homopolymer. Acrylic acid homopolymers P2) preferably have a number-average molecular weight in the range from 800 to 70 000 g/mol, more preferably 900 to 50 000 g/mol, particularly 1000 to 20 000 g/mol and especially 1000 to 10 000 g/mol. In this context, the term “acrylic acid homopolymer” also encompasses polymers in which the carboxylic acid groups are in partly or fully neutralized form. These include acrylic acid homopolymers in which the carboxylic acid groups are present partly or completely in the form of alkali metal salts or ammonium salts. Preference is given to acrylic acid homopolymers in which the carboxylic acid groups are protonated or are partly or completely in the form of sodium salts. Homopolymers of acrylic acid particularly suitable as polymers P2) are the Sokalan® PA brands from BASF SE.

In a second specific embodiment of the homo- and copolymers of acrylic acid and/or methacrylic acid, polymer P2) used is a copolymer comprising at least one copolymerized acrylic acid monomer selected from acrylic acid, acrylic salts and mixtures thereof and at least one copolymerized maleic monomer selected from maleic acid, maleic anhydride, maleic salts and mixtures thereof. These preferably have a number-average molecular weight in the range from 2500 to 150 000 g/mol, more preferably 2800 to 70 000 g/mol, particularly 2900 to 50 000 g/mol and especially 3000 to 30 000 g/mol. Also included here are copolymers in which the carboxylic acid groups are in partly or fully neutralized form. For this purpose, it is either possible to use monomers in salt form for polymerization or for the resulting copolymer to be subjected to partial or complete neutralization. Preference is given to copolymers in which the carboxylic acid groups are protonated or are partly or completely in the form of alkali metal salts or ammonium salts. Preferred alkali metal salts are sodium or potassium salts, especially the sodium salts.

Preferred polymers P2) are copolymers of maleic acid (or maleic monomers) and acrylic acid (or acrylic monomers) in a weight ratio of 10:90 to 95:5, more preferably those in a weight ratio of 30:70 to 90:10.

Preferred polymers P2) are also terpolymers of maleic acid (or maleic monomers), acrylic acid (or acrylic monomers) and a vinyl ester of a C₁-C₃ carboxylic acid in a weight ratio of 10 (maleic acid):90 (acrylic acid+vinyl ester) to 95 (maleic acid):10 (acrylic acid+vinyl ester). The weight ratio of acrylic acid to vinyl ester is preferably within a range from 30:70 to 70:30.

Particularly suitable polymers P2) based on acrylic monomers and maleic monomers are the corresponding Sokalan® CP brands from BASF SE.

In a third specific embodiment of the homo- and copolymers of acrylic acid and/or methacrylic acid, polymer P2) used is a copolymer comprising at least one (meth)acrylic acid monomer selected from (meth)acrylic acid, (meth)acrylic salts and mixtures thereof and at least one hydrophobic monomer. The hydrophobic monomer is especially selected from C₁-C₈-alkyl esters of (meth)acrylic acid, for example the methyl, ethyl, n- and isopropyl, n-butyl and 2-ethylhexyl esters of (meth)acrylic acid and C₂-C₁₀ olefins, for example ethene, propene, 1,2-butene, isobutene, diisobutene, styrene and α-methylstyrene.

In a further preferred embodiment, the polymer P2) used is a copolymer of at least one maleic monomer selected from maleic acid, maleic anhydride, maleic salts and mixtures thereof with at least one C₂-C₈ olefin. Also suitable are copolymers comprising at least one copolymerized maleic monomer selected from maleic acid, maleic anhydride, maleic salts and mixtures thereof, at least one copolymerized C₂-C₈ olefin and at least one other different copolymerized comonomer.

Particular preference is given to copolymers comprising at least one copolymerized maleic monomer selected from maleic acid, maleic anhydride, maleic salts and mixtures thereof and at least one copolymerized C₂-C₈ olefin as the sole monomers. These preferably have a number-average molecular weight in the range from 3000 to 150 000 g/mol, more preferably 5000 to 70 000 g/mol, particularly 8000 to 50 000 g/mol and especially 10 000 to 30 000 g/mol. Also included here are copolymers in which the carboxylic acid groups are in partly or fully neutralized form. For this purpose, it is either possible to use maleic salts for polymerization or for the resulting copolymer to be subjected to partial or complete neutralization. Preference is given to copolymers in which the carboxylic acid groups are protonated or are partly or completely in the form of alkali metal salts or ammonium salts. Preferred alkali metal salts are sodium or potassium salts, especially the sodium salts.

A specific embodiment is copolymers of maleic acid with C₂-C₈ olefins in a molar ratio of 40:60 to 80:20, particular preference being given to copolymers of maleic acid with ethylene, propylene, isobutene, diisobutene, isoprenol or styrene. Particularly suitable compounds which contain carboxylic acid groups and are based on olefins and maleic acid are likewise the corresponding Sokalan® CP brands from BASF SE.

A further preferred embodiment is that of copolymers comprising at least one copolymerized maleic monomer selected from maleic acid, maleic anhydride, maleic salts and mixtures thereof, at least one copolymerized C₂-C₈ olefin and at least one copolymerized acrylic monomer selected from acrylic acid, acrylic salts and mixtures thereof.

A further preferred embodiment is that of copolymers comprising at least one copolymerized maleic monomer selected from maleic acid, maleic anhydride, maleic salts and mixtures thereof, at least one copolymerized C₂-C₈ olefin and at least one copolymerized ester of (meth)acrylic acid. In that case, the ester of (meth)acrylic acid is especially selected from 01-C8-alkyl esters of (meth)acrylic acid, for example the methyl, ethyl, n- and isopropyl, n-butyl and 2-ethylhexyl esters of (meth)acrylic acid.

In a further preferred embodiment, the polymers P2) are selected from homo- and copolymers comprising at least one monomer comprising sulfonic acid groups.

Preferred monomers comprising sulfonic acid groups are selected from 1-acrylamido-1-propanesulfonic acid, 2-acrylamido-2-propanesulfonic acid, 2-acrylamido-2-methylpropanesulfonic acid (AMPS), 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and the salts of said acids. Suitable salts are generally water-soluble salts, preferably the sodium, potassium and ammonium salts of said acids.

Particular preference is given to 1-acrylamidopropanesulfonic acid, 2-acrylamido-2-propanesulfonic acid, 2-acrylamido-2-methylpropanesulfonic acid (AMPS), 2-methacrylamido-2-methylpropanesulfonic acid, 3-methacrylamido-2-hydroxypropanesulfonic acid, 2-hydroxy-3-(2-propenyloxy)propanesulfonic acid, 2-sulfoethyl methacrylate, styrenesulfonic acid, vinylsulfonic acid, allylsulfonic acid and methallylsulfonic acid, and also salts of said acids.

Very particularly preferred monomers comprising sulfonic acid groups are 2-acrylamido-2-methylpropanesulfonic acid (AMPS) and allylsulfonic acid, and water-soluble salts thereof, in particular sodium, potassium and ammonium salts thereof.

Particular copolymers and terpolymers are:
copolymers of 2-acrylamido-2-methylpropane sulfonic acid and acrylic acid,
copolymers of acrylic acid and 2-acrylamido-2-methylpropane sulfonic acid,
copolymers of acrylic acid and allylsulfonic acid,
terpolymers of 2-acrylamido-2-methyl-propane sulfonic acid, acrylic acid and itaconic acid,
terpolymers of isoprenol, maleic acid and 2-acrylamido-2-methylpropane sulfonic acid,
terpolymers of isoprenol, maleic acid and allylsulfonic acid.

In a further preferred embodiment, the polymers P2) are selected from homo- and copolymers comprising at least one copolymerized monomer selected from acrylamide, methacrylamide and mixtures thereof. These polymers P2) are preferably water-soluble or water-dispersible. These polymers P2) are especially water-soluble.

In a specific embodiment, the polymers P2) are selected from homopolymers of acrylamide or methacrylamide.

In a further specific embodiment, the polymers P2) are selected from copolymers of acrylamide and/or methacrylamide. These comprise at least one copolymerized comonomer selected from hydrophilic monomers (A1) other than acrylamide and methacrylamide, monoethylenically unsaturated amphiphilic monomers (A2) and further ethylenically unsaturated monomers (A3).

Suitable hydrophilic monoethylenically unsaturated monomers (A1) are uncharged monomers such as N-methyl(meth)acrylamide, N,N′-dimethyl(meth)acrylamide or N-methylol(meth)acrylamide, monomers comprising hydroxyl and/or ether groups, for example hydroxyethyl (meth)acrylate, hydroxypropyl (meth)acrylate, allyl alcohol, hydroxyvinyl ethyl ether, hydroxyvinyl propyl ether, hydroxyvinyl butyl ether, polyethylene glycol (meth)acrylate, N-vinylformamide, N-vinylacetamide, N-vinylpyrrolidone or N-vinylcaprolactam, and vinyl esters, for example vinyl formate or vinyl acetate. After polymerization, N-vinyl derivatives may be hydrolyzed to vinylamine units, and vinyl esters to vinyl alcohol units. Suitable hydrophilic monoethylenically unsaturated monomers (A1) are also monomers comprising at least one acidic group or salts thereof. These include acrylic acid, methacrylic acid, crotonic acid, itaconic acid, maleic acid, fumaric acid, vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid, 2-acrylamido-2,4,4-trimethylpentanesulfonic acid, vinylphosphonic acid, allylphosphonic acid, N-(meth)acrylamidoalkylphosphonic acids, (meth)acryloyloxyalkylphosphonic acids and salts and mixtures thereof. The further monoethylenically unsaturated hydrophilic monomers may be hydrophilic cationic monomers. Suitable cationic monomers (A1c) especially include monomers having ammonium groups, especially ammonium derivatives of N-(ω-aminoalkyl)(meth)acrylamides or ω-aminoalkyl (meth)acrylates.

The amphiphilic monomers (A2) are monoethylenically unsaturated monomers having at least one hydrophilic group and at least one, preferably terminal, hydrophobic group.

The monomers (A3) may, for example, be monoethylenically unsaturated monomers which have a more hydrophobic character than the hydrophilic monomers (A1) and are accordingly water-soluble only to a minor degree. Examples of such monomers include N-alkyl- and N,N′-dialkyl(meth)acrylamides, where the number of carbon atoms in the alkyl radicals together is at least 3, preferably at least 4. Examples of such monomers include N-butyl(meth)acrylamide, N-cyclohexyl(meth)acrylamide or N-benzyl(meth)acrylamide.

In a further preferred embodiment, the polymers P2) are selected from polyamino acids. Suitable polyamino acids are in principle compounds comprising at least one copolymerized amino acid such as aspartic acid, glutamic acid, lysine, glycine, etc. The polyamino acids also include the derivatives obtainable by polymer-analogous reaction, such as esterification, amidation, etc. Preferred polyamino acids are polyaspartic acid, polyaspartic acid derivatives, polyglutamic acid, polyglutamic acid derivatives and mixtures thereof.

Polyaspartic acid can be prepared, for example, by alkaline hydrolysis of polysuccinimide (PSI, anhydropolyaspartic acid). Polysuccinimide can be prepared by thermal condensation of aspartic acid or from ammonia and maleic acid. Polyaspartic acid can be used, for example, as a biodegradable complexing agent and cobuilder in washing and cleaning compositions.

Polyamino acids having surfactant properties can be obtained by at least partly converting the free carboxylic acid groups of polyaspartic acid or polyglutamic acid to N-alkylamides and/or to esters. Polyaspartamides can also be prepared by reaction of polysuccinimide with amines. For preparation of hydroxylethylaspartamides, the ring opening of polysuccinimide can be conducted with ethanolamine. DE 37 00 128 A and EP 0 458 079 A describe the subsequent esterification of such hydroxyethyl derivatives with carboxylic acid derivatives. Copolymeric polyaspartic esters are obtainable as described in DE 195 45 678 A by condensation of monoalkyl esters of maleic or fumaric acid with addition of ammonia. DE 195 45 678 A further states that copolymeric polyaspartic esters are obtainable by reaction of polysuccinimide with alcohols, optionally followed by hydrolysis. According to the esterification level and hydrophobicity of the alcohol component, polyaspartic esters, aside from their biodegradability, are notable for excellent properties as stabilizers for 0/W and W/O emulsions, as a foam-stabilizing and foam-boosting cosurfactant in washing and cleaning compositions, and as a complexing agent for metal cations.

In a further preferred embodiment, the polymers P2) are selected from polyalkylene glycols and mono- or diethers of polyalkylene glycols. Preferred polyalkylene glycols have a number-average molecular weight in the range from 1000 to 4 000 000 g/mol, more preferably from 1500 to 1 000 000 g/mol.

Suitable polyalkylene glycols and the mono- and diethers thereof may be linear or branched, preferably linear. Suitable polyalkylene glycols are, for example, water-soluble or water-dispersible nonionic polymers having repeat alkylene oxide units. Preferably, the proportion of repeat alkylene oxide units is at least 30% by weight, preferably at least 50% by weight and especially at least 75% by weight, based on the total weight of the compound. Suitable polyalkylene glycols are polyethylene glycols, polypropylene glycols, polytetrahydrofurans and alkylene oxide copolymers. Suitable alkylene oxides for preparation of alkylene oxide copolymers are, for example, ethylene oxide, propylene oxide, epichlorohydrin, 1,2- and 2,3-butylene oxide. Suitable examples are copolymers of ethylene oxide and propylene oxide, copolymers of ethylene oxide and butylene oxide, and copolymers of ethylene oxide, propylene oxide and at least one butylene oxide. The alkylene oxide copolymers may comprise the copolymerized alkylene oxide units in randomly distributed form or in the form of blocks. Preferably, the proportion of repeat units derived from ethylene oxide in the ethylene oxide/propylene oxide copolymers is 40% to 99% by weight. Particular preference is given to ethylene oxide homopolymers and ethylene oxide/propylene oxide copolymers.

Suitable mono- and diethers of polyalkylene glycols are the mono-(C₁-C₁₈-alkyl ethers) and di-(C₁-C₁₈-alkyl ethers). Preferred mono- and diethers of polyalkylene glycols are the mono-(C₁-C₆-alkyl ethers) and di-(C₁-C₆-alkyl ethers). Especially preferred are the mono-(C₁-C₂-alkyl ethers) and di-(C₁-C₂-alkyl ethers). Especially preferred are polyalkylene glycol monomethyl ethers and polyalkylene glycol dimethyl ethers.

Polymer mixtures are suitable, for example, for adjusting the mechanical properties and/or the dissolution properties of the multilayer films of the invention. The polymers used in the polymer mixture may differ in terms of their chemical composition and/or in terms of their physicochemical properties.

In a specific embodiment, the multilayer film of the invention comprises at least one layer comprising 2 or more polymers, selected from polymers P1), polymers P2) and mixtures thereof. According to this embodiment, at least one layer of the multilayer film may comprise 2 or more different polymers P1) or at least one polymer P1) and at least one polymer P2) or 2 or more different polymers P2).

In a first embodiment, a combination of 2 or more polymers which differ in terms of their chemical composition is used. In a second embodiment, a combination of 2 or more polymers which differ in terms of their molecular weight is used. According to this second embodiment, for example, a polymer mixture comprising at least two polymers P2) comprising repeat units which derive from vinyl alcohol is used.

### Production of Single and Multilayer Films

In principle, the film production process is not subject to any particular limitations and the person skilled in the art can apply any desired production process known to him on account of his specialist knowledge while using an aqueous composition comprising a polymer P1) and a polyoxyalkylene ether PE). The same is true for the production of coverings and coatings based on the obtained films.

Single layer films can be prepared preferably by casting processes and extrusion processes.

For the production of a single layer film by extrusion, an aqueous composition obtained according to step a) is extruded and blown in a blowing process or is extruded and formed in a thermoforming process to give a film. Optionally the film thus obtained is converted to a form suitable for the covering or coating of detergent or cleaner portions.

For the production of a single layer film by casting, an aqueous composition obtained according to step a), optionally after adding at least one additive, is melted or dissolved in a suitable solvent or solvent mixture, the thus obtained flowable polymer composition is cast to give a film and optionally the solvent or solvent mixture is removed by evaporation.

The solvent is preferably selected from water, ethanol, n-propanol, isopropanol, ethylene glycol, diethylene glycol, 1,2-propylene glycol, 1,2-dipropylene glycol and mixtures thereof. In a specific embodiment, the solvent used is water or a mixture of water and at least one solvent different from water, selected from ethanol, n-propanol, isopropanol, ethylene glycol, diethylene glycol, 1,2-propylene glycol, 1,2-dipropylene glycol and mixtures thereof.

To produce film portions, the film material can be confectioned in a suitable manner, e.g. by cutting into a suitable size and/or folding to form compartments. Then the edges can be sealed by customary sealing processes, such as hot sealing, liquid sealing or pressure sealing.

Multilayer films can be produced e.g. by a lamination method. Lamination methods in which two or more film layers are bonded to one another over their area are known to those skilled in the art. Lamination involves pressing two or more than two films together under elevated pressure and/or at elevated temperature. Multilayer films can also be produced by a wet-on-wet application method. In addition, multilayer films can also be produced by using combinations of the aforementioned production methods and the application method described hereinafter.

In a preferred embodiment, the multilayer film is produced by a process in which at least one free-flowing composition capable of film formation is applied to a carrier material, wherein the carrier material and/or the at least one free-flowing composition comprises a polymer P1) and a polyoxyalkylene ether PE) as defined above and hereinafter. In particular, the carrier material and/or the at least one pourable composition are obtained from an aqueous aqueous composition by mixing
a polymer P1) that comprises polymerized units of at least one monomer A), selected from α,β-ethylenically unsaturated carboxylic acids, salts of α,β-ethylenically unsaturated carboxylic acids and mixtures thereof,
an polyoxyalkylene ether PE) having at least one C₈-C₁₈-alkyl group that is unsubstituted or substituted by at least one hydroxyl group, and an average of 3 to 25 alkylene oxide units per molecule, and
water.

Reference is made to the aqueous composition obtained by step a) as defined above and hereinafter.

A further object of the invention is a process for producing a multilayer film, in which
a1) a first pourable composition capable of film formation is applied to a carrier material to obtain a first layer,
a2) the first layer applied to the carrier material is optionally subjected to an increase in viscosity,
a3) a second pourable composition capable of film formation is applied to the first layer obtained in step a1) or in step a2) to obtain a second layer,
a4) the second layer is optionally subjected to an increase in viscosity,
a5) step a3) is optionally repeated with a further composition capable of film formation to obtain a further layer and step a4) is optionally then repeated, it being possible to repeat steps a3) and a4) once or more than once,
a6) the layers applied to the carrier material are optionally subjected to a further increase in viscosity,
a7) the multilayer film obtained is optionally detached from the carrier material,
   with the proviso that the pourable compositions each comprise a component which is capable of film formation and is independently selected from aqueous compositions comprising a polymer P1) and an polyoxyalkylene ether PE), at least one polymer P2) or a mixture thereof, and with the proviso that the carrier material and/or the at least one pourable composition comprises a polymer P1) and a polyoxyalkylene ether PE) as defined above and hereinafter.

In a specific embodiment, the application of two or more than two of the pourable compositions can also be effected partly or fully simultaneously. For this purpose, for example, the application of the (n+1)th composition can be commenced before the application of the nth composition has completely ended.

In a further specific embodiment, the production of the multilayer film proceeds from a carrier material which already comprises the first film layer and optionally also already comprises further film layers of the multilayer film. In other words, a carrier material which already comprises the first film layer and optionally further film layers of the multilayer film is used in step a1). In this case, the carrier material forms part of the multilayer film and remains in the multilayer film after the application of all the further layers. This means that the further layers applied to the carrier material are not subsequently detached again from the carrier material. In this embodiment, there is therefore no step a7) of the above-described process.

The viscosity of the free-flowing composition is matched to the technical demands of the production method and is determined by factors including the concentration of the components capable of film formation, the solvent content (water), the additives added and the temperature.

The pourable compositions capable of film formation are applied in steps a1), a3) and a5) generally by means of standard methods, for example by means of methods selected from airblade coating, knife coating, airknife coating, squeegee coating, impregnation coating, dip coating, reverse roll coating, transfer roll coating, gravure coating, kiss coating, flow coating, cascade flow coating, slide coating, curtain coating, mono- and multilaminar slot die coating, spray coating, spin coating, or printing methods such as relief printing, intaglio printing, rotogravure printing, flexographic printing, offset printing, inkjet printing, letterpress printing, pad printing, heatseal printing or screenprinting methods. The application can also be continuous or semicontinuous, for example when the carrier material is moving, for example a permanently or intermittently moving belt.

Suitable carrier materials are firstly all materials which enable simple detachment of the finished multilayer film. Examples of these include glass, metals such as galvanized steel sheet or stainless steel, polymers such as silicones or polyethylene terephthalate, polymer-coated paper, such as silicone paper, etc. Suitable carrier materials are secondly monolaminar or multilaminar polymer films which remain as film layers in the multilayer film of the invention. With regard to the composition of these carrier materials, reference is made to the disclosure relating to the aqueous composition that comprises a polymer P1) and a polyoxyalkylene ether PE) and the disclosure relating to polymers P2).

The increase in viscosity in layers a2), a4) and a6) can be effected by means of standard methods and generally depends on the form in which pourable compositions capable of film formation have been applied in steps a1), a3) and a5). If they have been applied as a melt, for example, there is generally already an increase in viscosity in the course of cooling. The cooling can be effected by simply leaving the carrier material to stand or by active cooling, such as cooling of the carrier material, jetting with a cool gas (jet), cooling in a cold room/refrigerator and the like. If the free-flowing composition capable of film formation has been applied in the form of a solution or dispersion, it is generally necessary to remove at least some of the solvent, which can be effected, for example, by simply leaving the carrier material to stand, drying with an air jet or hot air jet, drying in drying cabinets, heating of the carrier material, application of a reduced pressure, optionally with simultaneous supply of heat, IR irradiation, microwave radiation, for example in a corresponding oven, and the like. Should the composition be curable, for example because the polymers present therein comprise as yet unconverted polymerizable/condensable groups, the increase in viscosity can alternatively or additionally be effected by curing the polymer. The measures suitable for curing depend on the polymerizable/condensable groups present. For instance, ethylenically unsaturated crosslinkable groups are especially cured by UV radiation; condensable groups, by contrast, generally cure either by being left to stand or with supply of heat. The heat can again be supplied as described above, i.e., for example, by incidence of warm or hot air or other warm or hot gases, drying in drying cabinets, heating of the carrier material, IR irradiation and the like. It is also possible to gelate the solution or dispersion applied by cooling, in the sense of forming a physical network extended over macroscopic dimensions, which likewise results in an increase in viscosity.

In a specific embodiment, the pourable compositions capable of film formation for two or more than two of the layers that form the multilayer film are applied by a wet-on-wet application method. The application in a3), a5) etc. can thus be effected wet-on-wet, meaning that the next layer can also be applied to the layer applied in step a1), a3) and/or a5) without an explicit step for increasing viscosity having been conducted beforehand. This is especially true when the layer to which the next polymer layer is applied is sufficiently thin, such that it solidifies sufficiently even without being explicitly left to stand, dried, heated, cured, etc. before the next layer is applied, and there is no complete mixing with the components of the next layer. This is also true when the two layers, i.e. those to which application is effected, and the layer applied subsequently do not have any strong tendency to mix, for example because one layer is based on an aqueous polymer solution/dispersion and the other on a hydrophobic organic solution/dispersion or a hydrophobic melt.

The polymers applied in steps a1), a3), a5) etc. are film-forming polymers. One or more than one of the layers comprising film-forming polymers may additionally comprise at least one additive.

In a particular embodiment, after steps a1), a2), a3), a4), a5) and/or a6), it is also possible to apply one or more layers that do not comprise any film-forming polymers. These are especially layers comprising components (functional materials) connected to the desired end use of the multilayer film. Should the film serve, for example, in or as a washing composition or as a sheath for washing compositions, these optional further layers may comprise surfactants, builders, cobuilders, bleaches, enzymes, enzyme stabilizers, graying inhibitors, optical brighteners, fragrances, bitter substances, dyes, etc. These components may, like the polymer layers too, be applied in solution/dispersion or melt. Suitable application techniques here too are those mentioned above.

The application of these layers may also be followed by a step of increasing the viscosity, or the next layer can be applied wet-on-wet. The statements made above apply analogously.

If the above-described layers that are applied do not comprise any film-forming polymers but do comprise components connected to the desired end use of the multilayer film, it is possible after steps a1), a2), a3), a4), a5) and/or a6), especially after steps a1), a3) and/or a5), to emboss or punch the polymer layer, so as to give rise to recesses in which the functional materials applied at a later stage can be accommodated in relatively large amounts. This can be effected by means of standard embossing, printing, stamping and punching tools.

The process of the invention allows the production of multilayer films without a complex lamination method in which the individual films have to be bonded to one another. It will be appreciated that the multilayer films of the invention can also be produced, as described above, by bonding two or more than two film layers to one another by laminating. For instance, multilaminar polymer films which serve as carrier material for application of further film layers may be provided by bonding two or more than two film layers to one another by laminating.

For provision of the compositions applied in steps a1), a3), a5) etc., for example, a component which is capable of film formation and is selected from aqueous compositions comprising a polymer P1) and a polyoxyalkylene ether PE), at least one polymer P2) or a mixture thereof, optionally after addition of at least one additive, is melted or dissolved in a suitable solvent or solvent mixture, the pourable composition thus obtained is poured out to form a layer and the solvent or solvent mixture is optionally removed by evaporation.

Suitable solvents and solvent mixtures are those described above as component S), to which reference is made here in its entirety. The solvent is more preferably selected from water, ethanol, n-propanol, isopropanol, ethylene glycol, diethylene glycol, 1,2-propylene glycol, 1,2-dipropylene glycol and mixtures thereof. In a specific embodiment, the solvent used is selected from water and a mixture of water and at least one solvent other than water, selected from ethanol, n-propanol, isopropanol, ethylene glycol, diethylene glycol, 1,2-propylene glycol, 1,2-dipropylene glycol and mixtures thereof.

In one specific embodiment of the present invention, a first two-ply film is brought together, in a lamination, with a second two-ply film.

The first two-ply film preferably comprises a layer 51), which comprises a polymer composition P1) or consists of a polymer composition P1), and a layer S2), which comprises at least one polymer P2) or consists of at least one polymer P2). The first two-ply film may be brought together with a second two-ply film, in a lamination, by steps a1) to a4), optionally after the drying of the second layer.

The second two-ply film may likewise be produced after steps (a) to (d), as described above, or simultaneously on a line connected in parallel. If the same composition is used for the mutually contacting plies of the two films, the multi-ply film produced via lamination in this way consists of three plies. If the outer plies are then chemically different, the resulting multilayer film has three chemically different plies. If the outer plies are also chemically identical, the resulting multilayer film has only two chemically different plies.

In a further embodiment of the present invention, a two-ply film is cut into two halves and then the two resulting film halves are laminated. When using a customary machine for producing film webs, the films can be cut centrally in machine direction, placed on top of one another and then laminated. In this embodiment as well, the production of the two-ply film may take place by steps a1) to a4) and optional drying of the second layer. In the case of this embodiment it is also possible to laminate the chemically identical interfaces with one another in order, effectively, to obtain a multilayer film composed of three plies, with the two outer plies being chemically identical.

The advantage of the two above-stated embodiments of the present invention lies in significantly accelerated drying as a result of the reduced layer thickness, which is associated directly with an increased production rate. Without being confined to the theory, the mass transport of the solvent through the film at a constant coefficient of diffusion is proportional to 1/film thickness.

A specific embodiment is a process for producing a washing- and cleaning-active single layer or multilayer polymer film, which comprises at least one additive. Additives can be added before or during the film formation in step b). Whether the addition takes place before or during step b) depends on the type and effect of the particular additive. For the film formation in step b) additives can be added to the aqueous composition before and/or during the film production.

In the case of multilayer films, an individual layer or a plurality of but not all the layers or all the layers may each comprise one or more than one additive. Alternatively or additionally, it is possible that at least one additive is present between at least two layers.

The additives may be auxiliaries for adjustment of the properties of the pourable compositions capable of film formation, typical additives of the washing and cleaning compositions or mixtures thereof.

A special embodiment is a single layer film that comprises at least one additive. A further special embodiment is a multilayer film in which at least one of the layers includes an additive. Particular preference is given to single layer and multilayer films in which at least one of the layers includes an additive which is a constituent customary for washing and cleaning compositions. In that case, the additive is preferably selected from nonionic, anionic, cationic and amphoteric surfactants, polymeric dispersants builders, complexing agents such as methylglycinediacetic acid, glutaminediacetic acid, glutamic acid diacetic acid and citric acid and the sodium and potassium salts thereof, bleaches, bleach activators, bleach catalysts, enzymes, enzyme stabilizers, bases, corrosion inhibitors, foam inhibitors, defoamers, wetting agents, dyes, pigments, fragrances, fillers, tableting aids, disintegrants, thickeners, solubilizers, organic solvents, electrolytes, pH modifiers, perfume carriers, bitter substances, fluorescers, hydrotropes, antiredeposition agents, optical brighteners, graying inhibitors, antishrink agents, anticrease agents, dye transfer inhibitors, antimicrobial active ingredients, antioxidants, anti-yellowing agents, antistats, ironing aids, hydrophobizing and impregnating agents, antiswell and antislip agents, plasticizers, scavengers, polymers other than the polymers P1) and the polymers P2), agents for modification of gas permeability and water vapor permeability, antistats, glidants, slip agents, UV absorbers and mixtures thereof.

Suitable enzymes and enzymes stabilizers are those mentioned in the following as component E1) of the detergent and cleaner formulations.

Suitable bitter substances are those mentioned in the following as component E6) of the detergent and cleaner formulations.

In a specific embodiment, the single layer film or one layer of the multilayer film comprises polyvinylpyrrolidone homo- and co-polymers or a polyvinylalcohol polymer and at least one enzyme as additive. In particular, the single layer film or at least one layer of the multilayer film comprises a polyvinylalcohol polymer and at least one enzyme as additive.

Some additives can fulfill several functions, e.g. as solvent S) and as plasticizer.

In order to make the polymer films more flexible, plasticizers can be added to them before or during production. For production of pourable compositions capable of film formation, preferably 0.5% to 30% by weight, more preferably 2% to 20% by weight and especially 3% to 15% by weight of plasticizer is used, based on the total weight of the composition.

Suitable plasticizers are alkyleneamines, alkanolamines, polyols, such as alkylene glycols and oligoalkylene glycols, e.g. 2-methyl-1,3-propanediol, 3-methyl-1,5-pentandiol, hydroxypropylglycerol, neopentyl glycol, alkoxylated glycerol (such as e.g. Voranol® from Dow Chemicals), water-soluble polyesterpolyols (such as e.g. TriRez from Geo Specialty Chemicals) and mixtures thereof. Suitable plasticizers are also polyetherpolyols, which are available under the name Lupranol® from BASF SE. The term “alkyleneamines” refers to condensation products of alkanolamines with ammonia or primary amines, e.g. ethyleneamines are obtained by reaction of monoethanolamine with ammonia in the presence of a catalyst. Here, the following result as main components: ethylenediamine, piperazine, diethylenetriamine and aminoethylethanolamine.

Preferably, the plasticizers are selected from glycerol, diglycerol, propylene glycols with a weight-average molecular weight of up to 400, dipropylene glycol, ethylene glycol, diethylene glycol, triethylene glycol, tetraethylene glycol, sorbitol, isopentyldiol, polyethylene glycol, trimethylolpropane, diethylenetriamine, triethylenepentamine, triethanolamine and mixtures thereof.

In order to make the polymer films according to the invention more resistant to aggressive ingredients (such as e.g. chlorine-releasing compounds, as are used in the area of disinfection of water, etc.), so-called “scavengers” (capture molecules) can be added to the film. Suitable scavengers are polyamines, polymeric polyamines, such as polyethyleneimines, poly(amidoamines) and polyamides. Moreover, it is also possible to use ammonium sulfate, primary and secondary amines with a low vapor pressure, such as ethanolamines, amino acid and salts thereof, and also polyamino acid and salts thereof, fatty amines, glucosamines and other aminated sugars. Furthermore, reducing agents, such as sulfites, bisulfites, thiosulfites, thiosulfates, iodides, nitrites and antioxidants such as carbamates, ascorbates and mixtures thereof can be used.

For production of the single layer and multilayer films, it is possible to add further additives in the form of polymers to the aqueous composition comprising the polymer P1) and the polyoxyalkylene ether PE) and/or to the polymers P2) before and/or during the film production. Typically, 0.05 to 20% by weight, preferably 0.1 to 15% by weight, particularly preferably 0.2 to 10% by weight, of polymers (based on the total weight of the polymer compounds, i.e. if present polymers P1) and the polyoxyalkylene ether PE), the polymers P2) and additional polymers) are used. Such additives can simultaneously improve the washing properties of the film, improve the mechanical properties of the film, and increase the resistance of the film to detergent components. Suitable polymers are e.g. oligosaccharides and polysaccharides, starch, degraded starches (maltodextrins), cellulose ethers, specifically hydroxyethylcellulose, hydroxypropylcellulose, methylcellulose, ethylcellulose, hydroxypropylmethylcellulose, hydroxypropylethylcellulose, microcrystalline cellulose, inulin, carboxymethylcellulose, e.g. in the form of the sodium salts, alginic acid and alginates, pectin acid and pectins, polyethyleneimines, alkoxylated, in particular ethoxylated polyethyleneimines, graft polymers of vinyl acetate on polyalkylene glycols, in particular on polyethylene glycols, homopolymers of N-vinylpyrrolidone, copolymers of N-vinylpyrrolidone and N-vinylimidazole, copolymers of N-vinylpyrrolidone with vinyl acetate and with vinylcaprolactam, polyalkylene oxides, polyvinyl alcohol, polyvinyl alcohols with fractions of nonhydrolyzed vinyl acetate, thickeners, such as, for example, xanthan gum, guar gum, gelatin, agar-agar and mixtures thereof.

It is additionally possible to subject at least one surface or both surfaces of the single and multilayer films of the invention to at least partial coating with at least one additive. Such a treatment may serve, for example, to provide the surface with particular properties, such as nonstick action, antistatic action, hydrophilic or hydrophobic properties, etc. It is thus possible to provide the single and multilayer films, for example, with better detachment properties from the carrier material used in the production, better roll-off properties, better glide properties, reduced tack, better compatibility with particular components ensheathed or coated therewith, etc. According to the nature and formulation of the additive, the application can be effected by standard methods, for example by spraying, dipping, powder application, etc. Suitable additives for coating of the surface of the multilayer films of the invention are, for example, talc, surfactants such as silicone-containing surfactants, waxes, etc.

It is also possible for the multilayer films of the invention to be printed or embossed, in order, for example, to provide them with patterns, designs or indicia. Printing may take place subsequent to the production of the multilayer film, or in an intermediate step during the construction of the layers. This printing step preferably takes place directly following film production, in-line; in a separate printing and/or converting operation; or in-line with the pod production. Suitable printing techniques are ink-jet printing, and also intaglio and planographic processes such as flexographic printing, gravure printing, offset printing or inkjet printing.

The film production process is not subject to any particular restrictions and the person skilled in the art is able to apply any desired production process of which he is aware on account of his art knowledge. The same applies to the production of single and multilayer films which are to be used as such for use as a washing composition or as a cleaning composition. The same applies to the production of sheaths and coatings based on a single or multilayer film of the invention. Particularly suitable methods are coating bar methods, casting methods, roll application methods and extrusion methods.

### Characterization of the Single and Multilayer Films

Preferably, the single layer films of the invention have a weight proportion of polymer P1) and polyoxalkylene ether PE) in the layer in the range from 0.1 to 100 mg/cm² of film, more preferably of 1 to 80 mg/cm² of film.

Preferably, the multilayer films have a total polymer weight (i.e. of all the components P1) and polyoxalkylene ether PE) and P2), if present) per layer in the range from 0.1 to 100 mg/cm² of film, more preferably of 1 to 80 mg/cm² of film.

The layer thickness of the single layer and multilayer films is variable within wide ranges and is dependent on the field of use of the films.

Preferably, the single layer films for ensheathing or coating a washing or cleaning composition have a layer thickness per layer in the range from 0.5 to 500 μm, preferably from 1 to 250 μm.

Preferably, the multilayer films for ensheathing or coating a washing or cleaning composition have a layer thickness per layer in the range from 0.5 to 500 μm, preferably from 1 to 250 μm.

Preferably, two-layer films for ensheathing or coating a washing or cleaning composition have a total layer thickness in the range from 1 to 1000 μm, preferably from 2 to 750 μm.

Preferably, three-layer films for ensheathing or coating a washing or cleaning composition have a total layer thickness in the range from 1.5 to 1500 μm, preferably from 2 to 1250 μm.

The single layer and multilayer films feature good mechanical properties. These are shown, for example, in tensile tests on film strips of the multilayer films as described in standards EN ISO 527-1 and ASTM D882-12. EN ISO 527-1 (current ISO version February 2012) is a European standard for plastics for determination of the tensile properties, which are ascertained by a tensile test with a tensile tester. For these tests, it is possible to use a standard apparatus, for example a universal tester from Zwick GmbH, model TMTC-FR2.5TN.D09. To achieve homogeneous test conditions, the films can first be subjected to storage for several days in equilibrium with the ambient humidity (35-40% relative humidity at 20-25° C.).

Tensile strength is a material property which states the maximum mechanical tensile stress that the material withstands before breaking/tearing. Preferably, the films of the invention have a tensile strength in the range from 3 to 40 N/mm².

Elongation is a dimensionless parameter which is reported in percent. Preferably, the films of the invention have an elongation of 20% to 500%.

### Detergents and Cleaners

The washing- and cleaning-active single layer and multilayer polymer films according to the invention are advantageously suitable for use for the portionwise packaging of detergents and cleaners. They are suitable firstly specifically for producing a covering which comprises solid or liquid or gel-like detergents or cleaners or at least one of their components. The washing- and cleaning-active polymer films according to the invention are furthermore suitable for producing a coating on a solid detergent or cleaner or on at least one solid component thereof. The polymer films dissolve at the start of the particular application (e.g. in the washing and dishwashing water), thus release the ingredients of the detergents and cleaners and contribute in dissolved form, on account of their dispersing, film-inhibiting, emulsifying and surface-active properties, to the washing and cleaning performance to a considerable extent. They improve the primary detergency, i.e. they help actively to remove the dirt from the fabric. Furthermore, they prevent a redeposition of removed dirt on the washed fabric, i.e. they have an anti-greying effect (secondary detergency). In particular they prevent the redeposition of particulate dirt, like clay particles, soot particles and color pigments. On account of their washing effect, they are suitable especially for the formulation of detergents.

The detergent or cleaner portions according to the invention comprise, as covering and/or coating, at least one washing- or cleaning-active polymer film according to the invention. In the inside of this covering or coating, the detergent or cleaner portions according to the invention comprise measured amounts of at least one washing-active or cleaning-active composition. In this connection, it is possible that the detergent or cleaner portions comprise only a single washing- or cleaning-active composition. It is also possible that the detergent or cleaner portions according to the invention comprise two or more than two different washing- or cleaning-active compositions. The different compositions can be surrounded by identical or different covering and/or coating. In this connection, at least one of the coverings and/or coatings comprises a washing- or cleaning-active polymer film according to the invention. The different compositions can be different as regards the concentration of the individual components (quantitive) and/or as regards the type of individual components (qualitative). It is particularly preferred that the components are adapted, as regards type and concentration, to the tasks which the active ingredient portion packs have to perform in the washing or cleaning operation.

The washing- and cleaning-active polymer films according to the invention are also advantageously suitable for producing so-called multichamber systems. Multichamber systems have 2, 3, 4, 5 or more than 5 chambers which each comprise a single or more than one component of a detergent or cleaner. In this connection, it may in principle be a single washing- or cleaning-active ingredient, a single auxiliary or any desired mixture of two or more than two active ingredients and/or auxiliaries. The ingredients of the individual chambers may be liquid, gel-like or solid. Multichamber systems are appropriate, for example, for separating from one another components of a detergent or cleaner that are incompatible or not very compatible. Thus, e.g. one chamber can comprise one or more enzymes(s) and another chamber can comprise at least one bleach. Multichamber systems are appropriate for example also in order to facilitate controlled release of a certain component e.g. at a certain time point in the washing or cleaning operation. For this, e.g. film materials of different material thickness can be used. Furthermore, individual chambers can be produced using a polymer film according to the invention and others can be produced using a conventional film different therefrom.

Wherever data relating to the qualitative and quantitative composition of detergents and cleaners is given hereinbelow, this should always comprise a formulation of this composition as multichamber system. In this connection, the chambers can in each case comprise one individual or several components of the formulation or the total amount of one component can be divided between two or more than two chambers.

The detergent or cleaner portions according to the invention comprise at least one washing- or cleaning-active composition in the inside. These compositions may be any desired substances or substance mixtures relevant in connection with a washing or cleaning operation. These are primarily the actual detergents or cleaners with their individual components explained in more detail below.

In the context of the present invention, detergents are understood here as meaning those products which are used for the cleaning of flexible materials with high absorbency, e.g. of materials with a textile character, whereas cleaners in the context of the present invention are understood as meaning those products which are used for the cleaning of materials with a closed surface, i.e. with a surface which has no or only few and small pores and consequently has only low absorbency, if any.

Examples of flexible materials with high absorbency are those which comprise natural, synthetic or semisynthetic fiber materials or consist thereof and which accordingly generally have at least partially a textile character. The materials containing or consisting of fibers can in principle be present in any form occurring in use or in production and processing. For example, fibers can be present in an unarranged manner in the form of flocks or heaps, arranged in the form of threads, yarns, twines, or in the form of sheet structures such as nonwovens, loden materials or felt, wovens, knits in all conceivable types of binding. The fibers may be raw fibers or fibers in any desired stages of processing. Examples are natural protein or cellulose fibers, such as wool, silk, cotton, sisal, hemp or coconut fibers, or synthetic fibers such as, for example, polyester, polyamide or polyacrylonitrile fibers.

Examples of cleaners which can comprise the washing- and cleaning-active polymer film according to the invention comprise detergents and cleaners, dishwashing detergents, such as hand dishwashing detergents or machine dishwashing detergents (ADW detergents), metal degreasers, glass cleaners, floor cleaners, all-purpose cleaners, high-pressure cleaners, neutral cleaners, alkaline cleaners, acidic cleaners, spray degreasers, dairy cleaners, commercial kitchen cleaners, apparatus cleaners in industry, especially the chemical industry, cleaners for car washing and also household all-purpose cleaners. Example of materials to be cleaned which have no pores or only a few small pores and have no or only low absorbency are metal, glass, enamel or ceramic. Typical objects made of these materials are e.g. metallic sinks, cutlery, glass and porcelain dishes, bathtubs, washbasins, tiles, flags, cured synthetic resins, such as e.g. decorative melamine resin surfaces on kitchen furniture or painted metal surfaces such as e.g. refrigerators and car bodies, printed circuit boards, microchips, sealed or painted woods, e.g. parquet or wall claddings, window frames, doors, coverings made of plastic such as floor coverings made of PVC or hard rubber, or rigid or flexible foams with largely closed surfaces.

Examples of cleaners which can comprise the washing- and cleaning-active polymer film according to the invention comprise detergents and cleaners, dishwashing detergents, such as hand dishwashing detergents or machine dishwashing detergents (dishwashing compositions for the dishwasher), metal degreasers, glass cleaners, floor cleaners, all-purpose cleaners, high-pressure cleaners, neutral cleaners, alkaline cleaners, acidic cleaners, spray degreasers, dairy cleaners, commercial kitchen cleaners, apparatus cleaners in industry, especially the chemical industry, cleaners for car washing and also household all-purpose cleaners.

The detergents or cleaners according to the invention may be portions, packaged in bags, of solid, liquid or gel-like detergents or cleaners. In a specific embodiment, they are so-called pouches (liquid tabs). Furthermore, they may be compressed moldings, such as tablets (“tabs”), blocks, briquettes, etc. In a specific embodiment, they are tablet-shaped detergents or cleaners.

The detergent or cleaner according to the invention preferably comprises the following constituents:
A) at least covering and/or coating comprising or consisting of a washing- and cleaning-active polymer film according to the invention,
B) at least one surfactant,
C) at least one builder,
D) optionally at least one bleach system,
E) optionally at least one further additive, which is preferably selected from enzymes, enzyme stabilizers, bases, corrosion inhibitors, antifoams, dyes, fragrances, fillers, tableting auxiliaries, disintegrants, thickeners, solubility promoters, organic solvents, electrolytes, pH extenders, perfume carriers, bitter substances, fluorescent agents, hydrotropes, antiredeposition agents, optical brighteners, graying inhibitors, shrink preventers, anticrease agents, color transfer inhibitors, antimicrobial active ingredients, antioxidants, anti-yellowing agents, antistats, ironing aids, phobicization and impregnation agents, swelling and slip-resist agents and UV absorbers, and
F) optionally water.

In the context of the present invention, the builder C) also comprises compounds referred to as sequestrants, builder, complexing agent, chelator, chelating agent or softener.

The bleach systems D) comprise, besides bleaches, optionally also bleach activators, bleach catalysts and/or bleach stabilizers.

Particularly preferably, the detergent and cleaner according to the invention comprises at least one enzyme and optionally at least one enzyme stabilizer as additive E).

A preferred embodiment relates to liquid or gel-like detergents or cleaners comprising:
A) 0.1 to 20% by weight of at least one covering and/or coating, comprising or consisting of a washing- and cleaning-active polymer film according to the invention,
B) 1 to 80% by weight of at least one surfactant,
C) 0.1 to 50% by weight of at least one builder,
D) 0 to 20% by weight of a bleach system,
E) 0.1 to 60% by weight of at least one further additive, which is preferably selected from enzymes, enzyme stabilizers, bases, corrosion inhibitors, antifoams, dyes, fragrances, fillers, tableting auxiliaries, disintegrants, thickeners, solubility promoters, organic solvents, electrolytes, pH extenders, perfume carriers, bitter substances, fluorescent agents, hydrotropes, antiredeposition agents, optical brighteners, graying inhibitors, shrink preventers, anticrease agents, color transfer inhibitors, antimicrobial active ingredients, antioxidants, anti-yellowing agents, antistats, ironing aids, phobicization and impregnation agents, swelling and slip-resist agents and UV absorbers, and
F) 0 to 98.7% by weight of water.

The percent by weight data refer here to the total weight of the detergent and cleaner. The weight amounts of A) to F) add up to 100% by weight.

Preferably, the liquid or gel-like detergents or cleaners comprise up to 70% by weight of water, particularly preferably up to 50% by weight of water, in particular up to 30% by weight of water.

A further preferred embodiment relates to solid detergents or cleaners comprising:
A) 0.1 to 20% by weight of at least one covering and/or coating, comprising or consisting of a washing- and cleaning-active polymer film according to the invention,
B) 1 to 50% by weight of at least one surfactant,
C) 0.1 to 70% by weight of at least one builder,
D) 0 to 30% by weight of a bleach system,
E) 0.1 to 70% by weight of at least one further additive, which is preferably selected from enzymes, enzyme stabilizers, bases, corrosion inhibitors, antifoams, dyes, fragrances, fillers, tableting auxiliaries, disintegrants, thickeners, solubility promoters, organic solvents, electrolytes, pH extenders, perfume carriers, bitter substances, fluorescent agents, hydrotropes, antiredeposition agents, optical brighteners, graying inhibitors, shrink preventers, anticrease agents, color transfer inhibitors, antimicrobial active ingredients, antioxidants, anti-yellowing agents, antistats, ironing aids, phobicization and impregnation agents, swelling and slip-resist agents and UV absorbers, and
   optionally water.

The percent by weight data refer here to the total weight of the detergent and cleaner. The weight amounts of A) to F) add up to 100% by weight.

### Component A)

As regards suitable and preferred washing- and cleaning-active polymer films according to the invention, reference is made to the statements above.

### Component B)

The detergents and cleaners according to the invention comprise as component B) can at least one surfactant. Suitable surfactants B) are nonionic, anionic, cationic or amphoteric surfactants.

In the context of the present invention, surfactants B) that can be used are, for example, nonionic surfactants (NIS). The nonionic surfactants used are preferably alkoxylated alcohols. Preference is given to alkoxylated primary alcohols. Preferred alkoxylated alcohols are ethoxylated alcohols having preferably 8 to 18 carbon atoms in the alkyl radical and on average 1 to 12 mol of ethylene oxide (EO) per mole of alcohol. The alcohol radical can be linear or preferably 2-methyl-branched and can comprise linear and methyl-branched radicals in a mixture, as are customarily present in oxo alcohol radicals. Particular preference is given to alcohol ethoxylates with linear or branched radicals from alcohols of native or petrochemical origin having 12 to 18 carbon atoms, for example from coconut, palm, tallow fatty or oleyl alcohol, and on average 2 to 8 EO per mole of alcohol.

The ethoxylated alcohols are preferably selected from:
C₁₂C₁₄-alcohols with 3 EO, 5 EO, 7 EO or 9 EO,
C₉C₁₁-alcohols with 7 EO,
C₁₃-oxo alcohols with 3 EO, 5 EO, 7 EO or 9 EO,
C₁₃C₁₅-alcohols with 3 EO, 5 EO, 7 EO or 9 EO,
C₁₂C₁₈-alcohols with 3 EO, 5 EO, 7 EO or 9 EO and mixtures thereof,
2-propylheptanol with 3 EO, 4 EO, 5 EO, 6 EO, 7 EO, 8 EO and 9 EO
   and mixtures of two or more than two of the aforementioned ethoxylated alcohols.

A preferred mixture of nonionic surfactants is a mixture of C₁₂C₁₄-alcohol (lauryl alcohol/myristyl alcohol) with 3 EO and C₁₂C₁₈-alcohol (lauryl alcohol/myristyl alcohol/cetyl alcohol/stearyl alcohol) with 7 EO. Preference is also given to mixtures of short-chain alcohol ethoxylates (e.g. 2-propylheptanol with 7 EO) and long-chain alcohol ethoxylates (e.g. C₁₆C₁₈ with 7 EO).

The stated degrees of ethoxylation are statistical averages (number averages, Mn), which may be an integer or a fraction for a specific product. Preferred alcohol ethoxylates have a narrowed homolog distribution (narrow range ethoxylates, NRE). In addition to these nonionic surfactants, it is also possible to use fatty alcohols with more than 12 EO. Examples thereof are tallow fatty alcohol with 14 EO, 25 EO, 30 EO or 40 EO. Nonionic surfactants which comprise ethylene oxide (EO) and propylene oxide (PO) groups together in the molecule can also be used. In this connection, it is possible to use block copolymers with EO-PO block units or PO-EO block units, but also EO-PO-EO copolymers or PO-EO-PO copolymers. It is of course also possible to use mixed alkoxylated nonionic surfactants in which EO and PO units are not blockwise but randomly distributed. Such products are obtainable by the simultaneous action of ethylene oxide and propylene oxide on fatty alcohols.

Surfactants suitable as component B) are also polyetherols, preferably with a number-average molecular weight of at least 200 g/mol.

Suitable polyetherols can be linear or branched, preferably linear. Suitable polyetherols have generally a number-average molecular weight in the range from about 200 to 100 000, preferably 300 to 50 000, particularly preferably 500 to 40 000. Suitable polyetherols are, for example, water-soluble or water-dispersible nonionic polymers which have alkylene oxide repeat units. Preferably, the fraction of alkylene oxide repeat units is at least 30% by weight, based on the total weight of the compound. Suitable polyetherols are polyalkylene glycols, such as polyethylene glycols, polypropylene glycols, polytetrahydrofurans and alkylene oxide copolymers. Suitable alkylene oxides for producing alkylene oxide copolymers are e.g. ethylene oxide, propylene oxide, epichlorohydrin, 1,2- and 2,3-butylene oxide. Of suitability are, for example, copolymers of ethylene oxide and propylene oxide, copolymers of ethylene oxide and butylene oxide, and copolymers of ethylene oxide, propylene oxide and at least one butylene oxide. The alkylene oxide copolymers can comprise the polymerized-in alkylene oxide units in randomly distributed form or in the form of blocks. Preferably, the fraction of repeat units derived from ethylene oxide in the ethylene oxide/propylene oxide copolymers is 40 to 99% by weight. Particular preference is given to ethylene oxide homopolymers and ethylene oxide/propylene oxide copolymers.

Moreover, further nonionic surfactants that can be used are also alkyl glycosides of the general formula (IV)

R¹⁰O(G)ᵢ (IV)

in which
R¹⁰ is a primary straight-chain or methyl-branched aliphatic radical having 8 to 22 carbon atoms,
G is a glycoside unit having 5 or 6 carbon atoms, and
i is any desired number between 1 and 10.

In the compounds of the formula (IV), R¹⁰ is preferably a 2-methyl-branched aliphatic radical having 8 to 22, preferably 12 to 18 carbon atoms.

G is preferably glucose.

The degree of oligomerization i, which indicates the distribution of monoglycosides and oligoglycosides, is preferably in a range from 1.2 to 1.4.

A further class of nonionic surfactants used with preference in the context of the present invention and which are used either as the sole nonionic surfactant or in combination with other nonionic surfactants are alkoxylated, preferably ethoxylated or ethoxylated and propoxylated fatty acid alkyl esters, preferably having 1 to 4 carbon atoms in the alkyl chain. Particular preference is given to fatty acid methyl esters, as are described, for example, in the Japanese patent application JP 58/217598, or which are produced preferably in accordance with the process described in the International patent application WO 90/13533.

Also suitable as nonionic are amine oxides, for example N-cocoalkyl-N,N-dimethylamine oxide and N-tallowalkyl-N,N-dihydroxyethylamine oxide, and fatty acid alkanolamides. These nonionic surfactants are preferably used as a mixture with alkoxylated alcohols. Preference is given to the mixture with ethoxylated fatty alcohols. The weight amount of these nonionic surfactants is preferably not more than that of the ethoxylated fatty alcohols, in particular not more than half thereof.

Further suitable surfactants B) are polyhydroxy fatty acid amides of the formula (V)

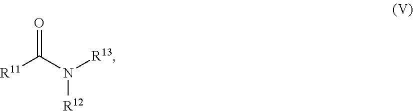

in which the group R¹¹—C(═O) is an aliphatic acyl radical having 6 to 22 carbon atoms, R¹² is hydrogen, an alkyl radical with 1 to 4 carbon atoms or a hydroxyalkyl radical having 1 to 4 carbon atoms, and R¹³ is a linear or branched polyhydroxyalkyl radical having 3 to 10 carbon atoms and 3 to 10 hydroxyl groups. The polyhydroxy fatty acid amides are known substances which can usually be obtained by reductive amination of a reducing sugar with ammonia, an alkylamine or an alkanolamine and subsequent acylation with a fatty acid, a fatty acid alkyl ester or a fatty acid chloride. The group of polyhydroxy fatty acid amides include in this connection also compounds of the formula (VI)

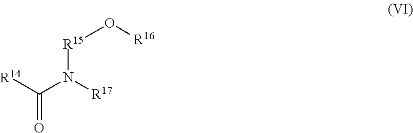

in which R¹⁴ is a linear or branched alkyl or alkenyl radical having 7 to 12 carbon atoms, R¹⁵ is a linear, branched or cyclic alkylene radical having 2 to 8 carbon atoms or an arylene radical having 6 to 8 carbon atoms, and R¹⁶ is a linear, branched or cyclic alkyl radical or an aryl radical or an oxyalkyl radical having 1 to 8 carbon atoms, where C₁-C₄-alkyl or phenyl radicals are preferred, and R¹⁷ is a linear polyhydroxyalkyl radical whose alkyl chain is substituted with at least two hydroxyl groups, or alkoxylated, preferably ethoxylated or propoxylated derivatives of this radical. R¹⁷ is preferably obtained by a reductive amination of a sugar, for example glucose, fructose, maltose, lactose, galactose, mannose or xylose. The N-alkoxy- or N-aryloxy-substituted compounds can then be converted to the desired polyhydroxy fatty acid amides for example in accordance with WO 95/07331 by reaction with fatty acid methyl esters in the presence of an alkoxide as catalyst.

Suitable surfactants B) are also anionic surfactants. Typical examples of anionic surfactants are soaps, alkylsulfonates, alkylbenzenesulfonates, olefinsulfonates, methyl ester sulfonates, sulfo fatty acids, alkyl sulfates, mono- and dialkyl sulfosuccinates, mono- and dialkyl sulfosuccinamates, sulfotriglycerides, amide soaps, ethercarboxylic acids and salts thereof, fatty acid isethionates, fatty acid sarcosinates, fatty acid taurides, N-acylamino acids, such as, for example, acyl lactylates, acyl tartrates, acyl glutamates and acyl aspartates, alkyl oligoglucoside sulfates, alkylglucose carboxylates, protein fatty acid condensates and alkyl (ether) phosphates.

A first preferred embodiment is anionic surfactants of the sulfonate and sulfate types. Preferred surfactants of the sulfonate type are C₉-C₁₃-alkylbenzenesulfonates, olefinsulfonates, i.e. mixtures of alkene- and hydroxyalkanesulfonates, and also disulfonates, as are obtained, for example, from C₁₂-C₁₈-monoolefins with terminal or pendent double bond by sulfonation with gaseous sulfur trioxide and subsequent alkaline or acidic hydrolysis of the sulfonation products. Also of suitability are alkanesulfonates, which are obtained from C₁₂-C₁₈-alkanes for example by sulfochlorination or sulfoxidation with subsequent hydrolysis and/or neutralization. Likewise of suitability are also the esters of α-sulfo fatty acids (estersulfonates), for example the α-sulfonated methyl esters of hydrogenated coconut, palm kernel or tallow fatty acids. Further suitable anionic surfactants are sulfated fatty acid glycerol esters.

Fatty acid glycerol esters are to be understood as meaning, inter alia, the mono-, di- and triesters, and mixtures thereof, as are obtained during the production by esterification of a monoglycerol with 1 to 3 mol of fatty acid or during the transesterification of triglycerides with 0.3 to 2 mol of glycerol. Preferred sulfated fatty acid glycerol esters here are the sulfation products of saturated fatty acids having 6 to 22 carbon atoms, for example of caproic acid, caprylic acid, capric acid, myristic acid, lauric acid, palmitic acid, stearic acid or behenic acid.

Preferred alk(en)yl sulfates are the alkali metal and in particular the sodium salts of the sulfuric acid half-esters of C₁₂-C₁₈-fatty alcohols, for example of coconut fatty alcohol, tallow fatty alcohol, lauryl, myristyl, cetyl or stearyl alcohol or of the C₁₀-C₂₀-oxo alcohols and the half-esters of secondary C₁₀-C₂₀-alcohols. Preference is furthermore given to alk(en)yl sulfates which comprise a synthetic straight-chain C₁₀-C₂₀-alkyl radical produced on a petrochemical basis. These have an analogous degradation behavior to the equivalent compounds based on fatty chemical raw materials. From the point of view of washing, the C₁₂-C₁₆-alkyl sulfates and C₁₂-C₁₅-alkyl sulfates and C₁₄-C₁₅-alkyl sulfates are preferred. 2,3-Alkyl sulfates, which are prepared for example in accordance with the U.S. Pat. No. 3,234,258 or 5,075,041 and can be obtained as commercial products of the Shell Oil Company under the name DAN®, are also suitable anionic surfactants. The sulfuric acid monoesters of the straight-chain or branched C₇-C₂₁-alcohols ethoxylated with 1 to 6 mol of ethylene oxide, such as 2-methyl-branched C₉-C₁₁-alcohols having on average 3.5 mol of ethylene oxide (EO) or C₁₂-C₁₈-fatty alcohols having 1 to 4 EO, inter alia, are also suitable. They are usually used in cleaners only in relatively small amounts, for example in amounts from 1 to 5% by weight, on account of their high foam behavior. Further suitable anionic surfactants in the context of the present invention are also the salts of alkylsulfosuccinic acid, which are also referred to as sulfosuccinates or as sulfosuccinic acid esters and are the monoesters and/or diesters of sulfosuccinic acid with alcohols, preferably fatty alcohols and in particular ethoxylated fatty alcohols. Preferred sulfosuccinates comprise C₈-C₁₈-fatty alcohol radicals or mixtures of these. Particularly preferred sulfosuccinates comprise a fatty alcohol radical which is derived from ethoxylated fatty alcohols. Here, in turn sulfosuccinates whose fatty alcohol radicals are derived from ethoxylated fatty alcohols with a narrow homolog distribution are particularly preferred. It is likewise also possible to use alk(en)ylsuccinic acid having preferably 8 to 18 carbon atoms in the alk(en)yl chain or salts thereof.

Particularly preferred anionic surfactants are soaps. Of suitability are saturated and unsaturated fatty acid soaps, such as the salts of lauric acid, myristic acid, palmitic acid, stearic acid, (hydrogenated) erucic acid and behenic acid, and also in particular soap mixtures derived from natural fatty acids, for example coconut, palm kernel, olive oil or tallow fatty acids.

The anionic surfactants including the soaps can be present in the form of their sodium, potassium or ammonium salts, and also as soluble salts of organic bases, such as mono-, di- or triethanolamine. Preferably, the anionic surfactants are present in the form of their sodium or potassium salts, in particular in the form of the sodium salts.

Suitable surfactants B) are also cationic surfactants. Particularly preferred cationic surfactants are:
C₇-C₂₅-alkylamines;
N,N-dimethyl-N-(hydroxy-C₇-C₂₅-alkyl)ammonium salts;
mono- and di(C₇-C₂₅-alkyl)dimethylammonium compounds quaternized with alkylating agents;
ester quats, in particular quaternary esterified mono-, di- and trialkanolamines esterified with C₈-C₂₂-carboxylic acids;
imidazoline quats, in particular 1-alkylimidazolinium salts of the formulae VII or VIII

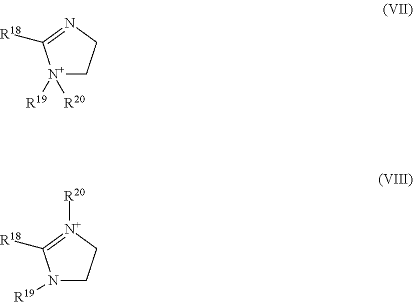

where the variables have the following meaning:
R¹⁸ is C₁-C₂₅-alkyl or C₂-C₂₅-alkenyl,
R¹⁹ is C₁-C₄-alkyl or hydroxy-C₁-C₄-alkyl,
R²⁰ is C₁-C₄-alkyl, hydroxy-C₁-C₄-alkyl or a radical R²¹—(CO)—R²²—(CH₂)ᵣ—, where R²¹ is H or C₁-C₄-alkyl, R²² is —O— or —NH— and r is 2 or 3, where at least one radical R¹⁸ is a C₇-C₂₂-alkyl radical.

The surfactants B) can also be amphoteric surfactants. Suitable amphoteric surfactants are alkylbetaines, alkylamidobetaines, alkylsulfobetaines, aminopropionates, aminoglycinates and amphoteric imidazolium compounds. For example, it is possible to use cocodimethylsulfopropylbetaine, laurylbetaine, cocamidopropylbetaine, sodium cocamphopropionate or tetradecyldimethylamine oxide.

The content of surfactants in liquid and gel-like detergent and cleaner compositions is preferably 2 to 75% by weight and in particular 5 to 65% by weight, in each case based on the total composition.

The content of surfactants in solid detergent and cleaner compositions is preferably 2 to 40% by weight and in particular 5 to 35% by weight, in each case based on the total composition.

### Component C

Builders, which are sometimes also referred to as sequestrants, builder material, complexing agent, chelator, chelating agent or softener, bind alkaline earth metals and other water-soluble metal salts without precipitating. They help to break up dirt, disperse dirt particles, help dirt to dissolve and sometimes have their own washing effect.

Suitable builders can either be organic or inorganic in nature. Examples are alumosilicates, carbonates, phosphates and polyphosphates, polycarboxylic acids, polycarboxylates, hydroxycarboxylic acids, phosphonic acids, e.g. hydroxyalkylphosphonic acids, phosphonates, aminopolycarboxylic acids and salts thereof and polymeric compounds containing carboxylic acid groups, and salts thereof.

Suitable inorganic builders are, for example, crystalline or amorphous alumosilicates with ion-exchanging properties, such as zeolites. Different types of zeolites are suitable, in particular zeolites A, X, B, P, MAP and HS in their Na form or in forms in which Na is in part exchanged for other cations such as Li, K, Ca, Mg or ammonium. Suitable zeolites are described for example in U.S. Pat. No. 4,604,224. Crystalline silicates suitable as builders are, for example, disilicates or sheet silicates, e.g. 5-Na₂Si₂O₅ or B—Na₂Si₂O₅ (SKS 6 or SKS 7). The silicates can be used in the form of their alkali metal, alkaline earth metal or ammonium salts, preferably as Na, Li and Mg silicates.

Amorphous silicates, such as, for example, sodium metasilicate, which has a polymeric structure, or amorphous disilicate (Britesil® H 20 manufacturer: Akzo) can likewise be used. Among these, preference is given to sodium disilicate.

Suitable inorganic builder substances based on carbonate are carbonates and hydrogencarbonates. These can be used in the form of their alkali metal, alkaline earth metal or ammonium salts. Preference is given to using Na, Li and Mg carbonates and hydrogencarbonates, in particular sodium carbonate and/or sodium hydrogencarbonate.

Customary phosphates used as inorganic builders are alkali metal orthophosphates and/or polyphosphates, such as e.g. pentasodium triphosphate.

Suitable organic builders are, for example, C₄-C₃₀-di-, -tri- and -tetracarboxylic acids, such as e.g. succinic acid, propanetricarboxylic acid, butanetetracarboxylic acid, cyclopentanetetracarboxylic acid and alkyl- and alkenylsuccinic acids with C₂-C₂₀-alkyl or -alkenyl radicals.

Suitable organic builders are also hydroxycarboxylic acids and polyhydroxycarboxylic acids (sugar acids). These include C₄-C₂₀-hydroxycarboxylic acids such as e.g. malic acid, tartaric acid, gluconic acid, mucic acid, lactic acid, glutaric acid, citric acid, tartronic acid, glucoheptonic acid, lactobionic acid and sucrosemono-, -di- and -tricarboxylic acid. Among these, preference is given to citric acid and salts thereof.

Suitable organic builders are also phosphonic acids, such as e.g. hydroxyalkylphosphonic acids, aminophosphonic acids and the salts thereof. These include e.g. phosphonobutanetricarboxylic acid, aminotrismethylenephosphonic acid, ethylene-diaminetetraethylenephosphonic acid, hexamethylenediaminetetramethylene-phosphonic acid, diethylenetriaminepentamethylenephosphonic acid, morpholino-methanediphosphonic acid, 1-hydroxy-C₁- to C₁₀-alkyl-1,1-diphosphonic acids such as 1-hydroxyethane-1,1-diphosphonic acid. Among these, preference is given to 1-hydroxyethane-1,1-diphosphonic acid and salts thereof.

Suitable organic builders are also aminopolycarboxylic acids, such as nitrilotriacetic acid (NTA), nitrilomonoaceticdipropionic acid, nitrilotripropionic acid, β-alaninediacetic acid (β-ADA), ethylenediaminetetraacetic acid (EDTA), diethylenetriaminepentaacetic acid, 1,3-propylenediaminetetraacetic acid, 1,2-propylenediaminetetraacetic acid, N-(alkyl)-ethylenediaminetriacetic acid, N-(hydroxyalkyl)-ethylenediaminetriacetic acid, ethylenediaminetriacetic acid, cyclohexylene-1,2-diaminetetraacetic acid, iminodisuccinic acid, hydroxyiminodisuccinic acid, ethylenediaminedisuccinic acid, serinediacetic acid, isoserinediacetic acid, L-asparaginediacetic acid, L-glutaminediacetic acid, methylglycinediacetic acid (MGDA) and the salts of the aforementioned aminopolycarboxylic acids. Preference is given to methylglycinediacetic acid, glutaminediacetic acid and salts thereof. The salts of methylglycinediacetic acid can be present as racemate, i.e. D- and L-enantiomers are present in equimolar mixture, or one enantiomer, e.g. the L-enantiomer, can be present in excess.

Suitable organic builders are also polymeric compounds containing carboxylic acid groups such as acrylic acid homopolymers. These preferably have a number-average molecular weight in the range from 800 to 70 000 g/mol, particularly preferably 900 to 50 000 g/mol, in particular 1000 to 20 000 g/mol, specifically 1000 to 10 000 g/mol. In this context, the term acrylic acid homopolymer also comprises polymers in which the carboxylic acid groups are present in partially or completely neutralized form. These include acrylic acid homopolymers in which the carboxylic acid groups are present partly or completely in the form of alkali metal salts or ammonium salts. Preference is given to acrylic acid homopolymers in which the carboxylic acid groups are present partly or completely in the form of sodium salts.

Suitable polymeric compounds containing carboxylic acid groups are also oligomaleic acids, as described for example in EP-A 451 508 and EP-A 396 303.

Suitable polymeric compounds containing carboxylic acid groups are also terpolymers of unsaturated C₄-C₈-dicarboxylic acids, where monoethylenically unsaturated monomers from the group (i) mentioned below in amounts of up to 95% by weight, from the group (ii) in amounts of up to 60% by weight and from the group (iii) in amounts of up to 20% by weight, can be polymerized-in as comonomers. Suitable unsaturated C₄-C₈-dicarboxylic acids here are, for example, maleic acid, fumaric acid, itaconic acid and citraconic acid. Preference is given to maleic acid. The group (i) comprises monoethylenically unsaturated C₃-C₈-monocarboxylic acids such as e.g. acrylic acid, methacrylic acid, crotonic acid and vinylacetic acid. From the group (i), preference is given to using acrylic acid and methacrylic acid. The group (ii) comprises monoethylenically unsaturated C₂-C₂₂-olefins, vinyl alkyl ethers with C₁-C₈-alkyl groups, styrene, vinyl esters of C₁-C₈-carboxylic acids, (meth)acrylamide and vinylpyrrolidone. From the group (ii), preference is given to using C₂-C₆-olefins, vinyl alkyl ethers with C₁-C₄-alkyl groups, vinyl acetate and vinyl propionate. If the polymers of group (ii) comprise vinyl esters in polymerized-in form, these may also be present partly or completely hydrolyzed to give vinyl alcohol structural units. Suitable co- and terpolymers are known for example from U.S. Pat. No. 3,887,806, and DE-A 4313909. The group (iii) comprises (meth)acrylic esters of C₁-C₈-alcohols, (meth)acrylonitrile, (meth)acrylamides of C₁-C₈-amines, N-vinylformamide and N-vinylimidazole.

Suitable polymeric compounds containing carboxylic acid groups are also homopolymers of the monoethylenically unsaturated C₃-C₈-monocarboxylic acids such as e.g. acrylic acid, methacrylic acid, crotonic acid and vinylacetic acid, in particular of acrylic acid and methacrylic acid, copolymers of dicarboxylic acids, such as e.g. copolymers of maleic acid or itaconic acid and acrylic acid in the weight ratio 10:90 to 95:5, particularly preferably those in the weight ratio 30:70 to 90:10 with molar masses from 1000 to 150 000; terpolymers of maleic acid, acrylic acid and a vinyl ester of a C₁-C₃-carboxylic acid in the weight ratio 10 (maleic acid):90 (acrylic acid+vinyl ester) to 95 (maleic acid):10 (acrylic acid+vinyl ester), where the weight ratio of acrylic acid to the vinyl ester can vary in the range from 30:70 to 70:30; copolymers of maleic acid with C₂-C₈-olefins in the molar ratio 40:60 to 80:20, where copolymers of maleic acid with ethylene, propylene or isobutene in the molar ratio 50:50 are particularly preferred. Suitable polymeric compounds containing carboxylic acid groups are also copolymers of 50 to 98% by weight of ethylenically unsaturated weak carboxylic acids with 2 to 50% by weight of ethylenically unsaturated sulfonic acids, as are described for example in EP-A-0877002. Suitable weak ethylenically unsaturated carboxylic acids are in particular C₃-C₆-monocarboxylic acids, such as acrylic acid and methacrylic acid. Suitable ethylenically unsaturated sulfonic acids are 2-acetylamidomethyl-1-propanesulfonic acid, 2-methacrylic amido-2-methyl-1-propanesulfonic acid, 2-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethylacrylamide, sulfomethylmethacrylamide and salts of these acids. The copolymers can also comprise, in polymerized-in form, 0 to 30% by weight of ethylenically unsaturated C₄-C₈-dicarboxylic acids, such as maleic acid, as well as 0 to 30% by weight of at least one monomer which is copolymerizable with the aforementioned monomers. The latter is, for example, C₁-C₄-alkyl esters of (meth)acrylic acid, C₁-C₄-hydroxyalkyl esters of (meth)acrylic acid, acrylamide, alkyl-substituted acrylamide, N,N-dialkyl-substituted acrylamide, vinylphosphonic acid, vinyl acetate, allyl alcohols, sulfonated allyl alcohols, styrene and other vinylaromatics, acrylonitrile, N-vinylpyrrolidone, N-vinylformamide, N-vinylimidazole or N-vinylpyridine. The weight-average molecular weight of these copolymers is in the range from 3000 to 50 000 Daltons. Copolymers with about 77% by weight of at least one ethylenically unsaturated C₃-C₆-monocarboxylic acid and about 23% by weight of at least one ethylenically unsaturated sulfonic acid are particularly suitable.

Graft polymers of unsaturated carboxylic acids on low molecular weight carbohydrates or hydrogenated carbohydrates, cf. U.S. Pat. No. 5,227,446, DE-A 4415623 and DE-A 4313909, are likewise suitable. Suitable unsaturated carboxylic acids here are, for example, maleic acid, fumaric acid, itaconic acid, citraconic acid, acrylic acid, methacrylic acid, crotonic acid and vinylacetic acid, and mixtures of acrylic acid and maleic acid, which are grafted on in amounts of from 40 to 95% by weight, based on the component to be grafted. For the modification, additionally up to 30% by weight, based on the component to be grafted, of further monoethylenically unsaturated monomers can be present in polymerized-in form. Suitable modifying monomers are the aforementioned monomers of groups (ii) and (iii). Suitable graft bases are degraded polysaccharides such as e.g. acidically or enzymatically degraded starches, inulins or cellulose, protein hydrolyzates and reduced (hydrogenated or reductively aminated) degraded polysaccharides such as e.g. mannitol, sorbitol, aminosorbitol and N-alkylglucamine, and also polyalkylene glycols with molar masses having up to M_{w}=5000 such as e.g. polyethylene glycols, ethylene oxide/propylene oxide or ethylene oxide/butylene oxide or ethylene oxide/propylene oxide/butylene oxide block copolymers and alkoxylated mono- or polyhydric C₁-C₂₂-alcohols (cf. U.S. Pat. No. 5,756,456).

Likewise of suitability are polyglyoxylic acids, as are described for example in EP-B-001004, U.S. Pat. No. 5,399,286, DE-A-4106355 and EP-A-656914. The end groups of the polyglyoxylic acids can have different structures.

Furthermore, polyamidocarboxylic acids and modified polyamidocarboxylic acids are suitable; these are known for example from EP-A-454126, EP-B-511037, WO-A94/01486 and EP-A-581452.

Polyaspartic acids and their alkali metal salts or cocondensates of aspartic acid with other amino acids, e.g. with glycine, glutamic acid or lysine, C₄-C₂₅-mono- or -dicarboxylic acids and/or C₄-C₂₅-mono- or -diamines can also be used as polymeric compounds containing carboxylic acid groups.

Among the polymeric compounds containing carboxylic acid groups, preference is given to polyacrylic acids also in partially or completely neutralized form.

Suitable organic builders are also iminodisuccinic acid, oxydisuccinic acid, aminopoly-carboxylates, alkylpolyaminocarboxylates, aminopolyalkylenephosphonates, poly-glutamates, hydrophobically modified citric acid such as e.g. agaricic acid, poly-[alpha]-hydroxyacrylic acid, N-acylethylenediamine triacetates such as lauroylethylenediamine triacetate and alkylamides of ethylenediaminetetraacetic acid such as EDTA tallow amide.

Furthermore, it is also possible to use oxidized starches as organic builders.

### Component D)

The bleach systems D) comprise at least one bleaching agent and optionally at least one further component selected from bleach activators, bleach catalysts and bleach stabilizers.

Suitable bleaching agents are, for example, percarboxylic acids, e.g. diperoxo-dodecanedicarboxylic acid, phthalimidopercaproic acid or monoperoxophthalic acid or -terephthalic acid, salts of percarboxylic acids, e.g. sodium percarbonate, adducts of hydrogen peroxide onto inorganic salts, e.g. sodium perborate monohydrate, sodium perborate tetrahydrate, sodium carbonate perhydrate or sodium phosphate perhydrate, adducts of hydrogen peroxide onto organic compounds, e.g. urea perhydrate, or of inorganic peroxo salts, e.g. alkali metal persulfates, or peroxodisulfates.

Suitable bleach activators are, for example, polyacylated sugars, e.g. pentaacetyl glucose; acyloxybenzenesulfonic acids and their alkali metal and alkaline earth metal salts, e.g. sodium p-nonanoyloxybenzenesulfonate or sodium p-benzoyloxybenzene sulfonate; N,N-diacylated and N,N,N′,N′-tetraacylated amines, e.g. N,N,N′,N′-tetraacetylmethylenediamine and -ethylenediamine (TAED), N,N-diacetylaniline, N,N-diacetyl-p-toluidine or 1,3-diacylated hydantoins such as 1,3-diacetyl-5,5-dimethyl hydantoin; N-alkyl-N-sulfonylcarboxamides, e.g. N-methyl-N-mesylacetamide or N-methyl-N-mesylbenzamide; N-acylated cyclic hydrazides, acylated triazoles or urazoles, e.g. monoacetylmaleic acid hydrazide; O,N,N-trisubstituted hydroxylamines, e.g. O-benzoyl-N,N-succinylhydroxylamine, O-acetyl-N,N-succinylhydroxylamine or O,N,N-triacetylhydroxylamine; N,N′-diacylsulfurylamides, e.g. N,N′-dimethyl-N,N′-diacetylsulfurylamide or N,N′-diethyl-N,N′-dipropionylsulfurylamide; acylated lactams such as, for example, acetylcaprolactam, octanoylcaprolactam, benzoylcaprolactam or carbonylbiscaprolactam; anthranil derivatives such as e.g. 2-methylanthranil or 2-phenylanthranil; triacylcyanurates, e.g. triacetyl cyanurate or tribenzoyl cyanurate; oxime esters and bisoxime esters such as e.g. O-acetylacetone oxime or bisisopropyl-iminocarbonate; carboxylic acid anhydrides, e.g. acetic anhydride, benzoic anhydride, m-chlorobenzoic anhydride or phthalic anhydride; enol esters such as e.g. isopropenyl acetate; 1,3-diacyl-4,5-diacyloxyimidazolines, e.g. 1,3-diacetyl-4,5-diacetoxy-imidazoline; tetraacetylglycoluril and tetrapropionylglycoluril; diacylated 2,5-diketo-piperazines, e.g. 1,4-diacetyl-2,5-diketopiperazine; ammonium-substituted nitriles such as e.g. N-methylmorpholinium acetonitrile methylsulfate; acylation products of propylenediurea and 2,2-dimethylpropylenediurea, e.g. tetraacetylpropylenediurea; α-acyloxypolyacylmalonamides, e.g. α-acetoxy-N,N′-diacetylmalonamide; diacyldioxo-hexahydro-1,3,5-triazines, e.g. 1,5-diacetyl-2,4-dioxohexahydro-1,3,5-triazine; benz-(4H)-1,3-oxazin-4-ones with alkyl radicals, e.g. methyl, or aromatic radicals e.g. phenyl, in the 2 position.

A bleach system of bleaching agents and bleach activators can optionally also comprise bleach catalysts. Suitable bleach catalysts are, for example, quaternized imines and sulfonimines, which are described for example in U.S. Pat. No. 5,360,569 and EP-A 453 003. Particularly effective bleach catalysts are manganese complexes, which are described for example in WO-A 94/21777. Such compounds are incorporated in the case of their use in detergents and cleaners at most in amounts up to 1.5% by weight, in particular up to 0.5% by weight, in the case of very active manganese complexes in amounts up to 0.1% by weight. Besides the described bleach system of bleaching agents, bleach activators and optionally bleach catalysts, the use of systems with enzymatic peroxide release or of photoactivated bleach systems is also possible for the detergents and cleaners according to the invention.

### Component E)

Suitable enzymes (=component E1) are those as are customarily used as industrial enzymes. These include both enzymes with optimum activity in the neutral to alkaline pH range, as well as enzymes with optimum activity in the acidic pH range. In a special embodiment, component E1) also comprises at least one enzyme stabilizer. Suitable enzymes stabilizers E1) are those that are customarily used.

The enzymes are preferably selected from aminopeptidases, amylases, arabinases, carbohydrases, carboxypeptidases, catalases, cellulases, chitinases, cutinases, cyclodextringlycosyltransferases, deoxyribonucleases, esterases, galactanases, alpha-galactosidases, beta-galactosidases, glucanases, glucoamylases, alpha-glucosidases, beta-glucosidases, haloperoxidases, hydrolaseinvertases, isomerases, keratinases, laccases, lipases, mannanases, mannosidases, oxidases, pectinolytic enzymes, peptidoglutaminases, peroxidases, peroxygenases, phytases, polyphenoloxidases, proteolytic enzymes, ribonucleases, transglutaminases, transferases, xylanases and mixtures thereof.

The enzymes are specifically selected from hydrolases, such as proteases, esterases, glucosidases, lipases, amylases, cellulases, mannanases, other glycosylhydrolases and mixtures of the aforementioned enzymes. All of these hydrolases contribute to the soil dissolving and removal of protein-, grease- or starch-containing soilings. Oxireductases can also be used for bleaching. Of particularly good suitability are enzymatic active ingredients obtained from bacterial strains or fungi such as Bacillus subtilis, Bacillus licheniformis, Streptomyceus griseus and Humicola insolens.

Preferred enzymes are described in more detail below:

### Proteases:

Suitable proteolytic enzymes (proteases) can in principle be of animal, vegetable or microbial origin. Preference is given to proteolytic enzymes of microbial origin. These also include chemically or genetically modified mutants.

### Lipases:

Suitable lipases can in principle originate from bacteria or fungi. These also include chemically or genetically modified mutants.

### Amylases:

In principle, all α- and/or β-amylases are suitable. Suitable amylases can in principle originate from bacteria or fungi. These also include chemically or genetically modified mutants.

### Cellulases:

In principle, all cellulases are suitable. Suitable cellulases can in principle originate from bacteria or fungi. These also include chemically or genetically modified mutants.

### Peroxidases/oxidases:

Suitable peroxidases/oxidases can in principle originate from plants, bacteria or fungi. These also include chemically or genetically modified mutants.

### Lyases:

In principle, all lyases are suitable. Suitable lyases can in principle originate from bacteria or fungi. These also include chemically or genetically modified mutants.

Compositions according to the invention can comprise further enzymes, which are summarized under the term hemicellulases. These include, for example, mannanases, xanthan lyases, pectin lyases (=pectinases), pectinesterases, xyloglucanases (=xylanases), pullulanases and β-glucanases.

Preferably, the detergent or cleaner according to the invention comprises at least one enzyme which is selected from proteases, amylases, mannanases, cellulases, lipases, pectin lyases and mixtures thereof.

Preferably, the detergent or cleaner according to the invention comprises at least one protease and/or amylase.

Preferably, the detergent, cleaner and dishwashing detergent according to the invention comprises an enzyme mixture. For example, preference is given to enzyme mixtures which comprise or consist of the following enzymes:
protease and amylase,
protease and lipase (or lipolytically acting enzymes),
protease and cellulase,
amylase, cellulase and lipase (or lipolytically acting enzymes),
protease, amylase and lipase (or lipolytically acting enzymes),
protease, lipase (or lipolytically acting enzymes) and cellulase.

The enzymes can be adsorbed onto carrier substances in order to protect them from premature decomposition.

The detergent or cleaner according to the invention can optionally also comprise enzyme stabilizers E1). These include e.g. calcium propionate, sodium formate, boric acids, boronic acids and salts thereof, such as 4-formylphenylboronic acid, peptides and peptide derivatives, such as e.g. peptide aldehydes, polyols, such as 1,2-propanediol, and mixtures thereof.

The detergents or cleaners according to the invention comprise the enzymes preferably in an amount of from 0.1 to 5% by weight, particularly preferably 0.12 to 2.5% by weight, based on the total weight of the detergents or cleaners.

In order to impart the desired viscosity to liquid and specifically aqueous compositions, at least one thickener (=component E2) can additionally be used as component E).

Of suitability in principle are any known thickeners (rheology modifiers) provided they do not have a negative influence on the effect of the detergent and cleaner. Suitable thickeners may either be of natural origin or synthetic in nature.

Examples of thickeners of natural origin are xanthan, carob seed flour, guar flour, carrageenan, agar, tragacanth, gum Arabic, alginates, modified starches, such as hydroxyethyl starch, starch phosphate esters or starch acetates, dextrins, pectins and cellulose derivatives, such as carboxymethylcellulose, hydroxyethylcellulose, hydroxypropylcellulose, hydroxypropylmethylcellulose, methylcellulose and the like.

Thickeners of natural origin are also inorganic thickeners, such as polysilicic acids and clay minerals, e.g. sheet silicates, like also the silicates specified under the builders. Examples of synthetic thickeners are polyacrylic and polymethacrylic compounds, such as (partially) crosslinked homopolymers of acrylic acid, for example with an allyl ether of sucrose or pentaerythritol or propylene-crosslinked homopolymers of acrylic acid (carbomer), e.g. the Carbopol® grades from BF Goodridge (e.g. Carbopol® 676, 940, 941, 934 or the like) or the Polygel® grades from 3V Sigma (e.g. Polygel® DA), copolymers of ethylenically unsaturated mono- or dicarboxylic acids, for example terpolymers of acrylic acid, methacrylic acid or maleic acid with methyl or ethyl acrylate and a (meth)acrylate derived from long-chain ethoxylated alcohols, for example the Acusol® grades from Rohm & Haas (e.g. Acusol® 820 or 1206A), copolymers of two or more monomers which are selected from acrylic acid, methacrylic acid and their C₁-C₄-alkyl esters, e.g. copolymers of methacrylic acid, butyl acrylate and methyl methacrylate or of butyl acrylate and methyl methacrylate, e.g. the Aculyn® and Acusol® grades from Rohm & Haas (e.g. Aculyn® 22, 28 or 33 and Acusol® 810, 823 and 830), or crosslinked high molecular weight acrylic acid copolymers, for example with an allyl ether of sucrose or pentaerythritol-crosslinked copolymers of C₁₀-C₃₀-alkyl acrylates with one or more comonomers which are selected from acrylic acid, methacrylic acid and their C₁-C₄-alkyl esters (e.g. Carbopol® ETD 2623, Carbopol® 1382 or Carbopol® AQUA 30 from Rohm & Haas).

Examples of synthetic thickeners are also reaction products of maleic acid polymers with ethoxylated long-chain alcohols, e.g. the Surfonic L series from Texaco Chemical Co. or Gantrez AN-119 from ISP; polyethylene glycols, polyamides, polyimines and polycarboxylic acids.

Also of suitability are mixtures of the aforementioned thickeners.

Preferred thickeners are xanthans and the aforementioned polyacrylic and polymethacrylic compounds.

Suitable organic solvents (=component E3) are selected from mono- or polyhydric alcohols, alkanolamines or glycol ethers. Preferably, they are selected from ethanol, n- or isopropanol, butanols, glycol, propane- or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or -ethyl ether, diisopropylene glycol monomethyl or -ethyl ether, methoxy, ethoxy or butoxy triglycol, isobutoxyethoxy-2-propanol, 3-methyl-3-methoxybutanol, propylene glycol t-butyl ether, and mixtures of these solvents.

Suitable foam inhibitors or antifoams (=component E4) are, for example, soaps, paraffins or silicone oils, which can optionally be applied to carrier materials.

Suitable bases (=component E5) are alkali metal hydroxides, alkaline earth metal hydroxides, alkali metal carbonates, alkaline earth metal carbonates, ammonium carbonate, alkali metal hydrogencarbonates, alkaline earth metal hydrogencarbonates, ammonium hydrogencarbonates and mixtures thereof. Preference is given to using Na, Li and Mg carbonates and hydrogencarbonates, in particular sodium carbonate and/or odium hydrogencarbonate.

Additionally, the detergents, cleaners or dishwashing detergents according to the invention can comprise further additives E6), which further improve the application and/or aesthetic properties. As a rule, preferred compositions comprise, in addition to the aforementioned components, at least one further additive which is selected from electrolytes, pH extenders, perfume carriers, bitter substances, fluorescent agents, hydrotropes, antiredeposition agents, optical brighteners, graying inhibitors, shrink preventers, anticrease agents, color transfer inhibitors, antimicrobial active ingredients, antioxidants, anti-yellowing agents, corrosion inhibitors, antistats, ironing aids, phobicization and impregnation agents, swelling and slip-resist agents, and UV absorbers.

Suitable dye transfer inhibitors are especially homo- or copolymers comprising at least one copolymerized monomer selected from N-vinylpyrrolidone, N-vinylcaprolactam, N-vinylimidazole, 2-vinylpyridine, 4-vinylpyridine, salts of the three latter monomers, 4-vinylpyridine N-oxide, N-carboxymethyl-4-vinylpyridinium halides and mixtures thereof.

Suitable graying inhibitors and/or washing power boosters are especially:
carboxymethylcellulose,
graft polymers of vinyl acetate onto carbohydrates, for example onto degraded starch,
graft polymers of vinyl acetate onto polyethylene glycol,
alkoxylated oligo- and polyamines, e.g. ethoxylated hexamethylenediamine, which may additionally also be in quaternized and/or sulfated form, or alkoxylated polyethyleneimine with 16 to 24 EO per NH,
copolymers based on styrene and maleic acid which may additionally also have been modified with end group-capped polyethylene glycol,
copolymers based on styrene and acrylic acid.

In order to improve the aesthetic impression of the detergents, cleaners or dishwashing detergents according to the invention, they can be colored using suitable dyes. Preferred dyes, the selection of which does not present the person skilled in the art with any difficulty, have high storage stability and insensitivity to the other ingredients of the compositions and towards light, as well as no more substantivity towards textile fibers so as not to stain these.

The detergents, cleaners or dishwashing detergents according to the invention can contain at least one bitter substance (bitterant). Bitter substances are used in particular to prevent the ingestion of the compositions by children. Suitable bitter substances are known to a person skilled in the art. A preferred bitter substance is denatonium benzoate (phenylmethyl-[2-[(2,6-dimethylphenyl)amino]-2-oxoethyl]-diethylammonium benzoate), the most bitter chemical compound known, commercially available as Bitrex®.

I & I cleaners

The washing- and cleaning-active polymer films according to the invention are also suitable for industrial and institutional cleaners (I & I cleaners). (Industrial and institutional cleaners are typically detergents, all-purpose cleaners, foam cleaners, CIP cleaners (cleaning in place cleaners) for professional and generally automated cleaning operations, e.g. in industrial laundries, dairies, breweries, the food and drink industry, the pharmaceutical industry or pharmaceutical technology, or sanitary cleaners.

The cleaners can be strongly basic with a high electrolyte content and, if required, comprise bleaching agents (such as hydrogen peroxide, sodium hypochlorite) or disinfectants and antifoams (e.g. in bottle cleaning). It is also possible for the customary aforementioned enzymes to be present in the industrial and institutional cleaners. As regards the types of cleaning for which the formulations according to the invention are suitable, there is great variety. By way of example, mention may be made of cleaning baths (stationary or mobile), spray cleaning, ultrasound cleaning, steam jet cleaning and high-pressure cleaning, optionally in combination with mechanical cleaning, e.g. by rotating brushes.

The specified formulations for cleaning include those for industry, transport, commerce and industry and for the private sector. Specific examples include: professional laundries, professional cleaning businesses, ore processing industry, metal and metalworking industry, automobile and automobile supply industry, electrical industry, electronics industry, photographic industry and businesses, leisure industry and businesses, construction material industry, brewing industry and businesses; food industry (e.g. processing or production of meat, poultry, dairy and fish products), animal nutrition industry, cosmetics industry, pharmaceutical industry, agrochemical industry, gastronomy, the health sector, workshops, and public transport. Examples of objects to be cleaned are institutional laundry, hospital laundry, laundry from laundry collections, buildings with living spaces, office spaces or commercial spaces of a very wide variety of different kinds, and sanitary spaces, warehouses, breweries, small businesses such as bakeries, butcheries and supermarkets; hospitals, care homes, homes for the elderly, administration buildings, factory buildings, doctor's practices; and also motor vehicles (cars and trucks), buses, road tanker vehicles (interior and exterior), rail tanker wagons, passenger vehicles and goods vehicles, and aircraft and ships; also building facades, tiled or painted walls, floors made of wood (parquet, boards) with screed or textile or plastic coverings, signaling and lighting installations, furniture, railings, overhead signage, other signage, safety reflectors, delineating markers, tanks, dishes, glass panes, roads and paths, outside paving, road and railway tunnels.

The invention is illustrated in more detail by reference to the figures and examples described below. Here, the figures and examples should not be construed as being delimiting for the invention.

### EXAMPLES

The following abbreviations were used:

EO: ethylene oxide, PO: 1,2-propylene oxide, BO: 1,2-butylene oxide, PEO: polyethylene oxide

The weight-averaged molecular weight of the polymers was determined by gel permeation chromatography (GPC). The following instruments and chromatography methods were used for this purpose:

Standard: polyacrylic acid, neutralized

Eluent: 0.01 mol/l phosphate buffer (=10 Na₂HPO₄+1.8 KH₂PO₄+2.7 KCl+137 NaCl in mmol/l), pH=7.4, +0.01 M NaN₃ in deionized water
Flow rate: 0.8 ml/min
Column set: 2 separating columns (I=30 cm each)
Column temperature: 35° C.

### Detector: RID (Refractive Index Detector) Agilent 1200°

### Polymers

The following polymers 1 to 6 were employed as polymers P1) in the sense of the invention for the preparation of polymer films.

Polymer 1: Polyacrylic acid, Mw 5000 g/mol, powder, pH (10% in water) 2.0

Polymer 1 was produced by free-radical polymerization of acrylic acid in water using sodium dioxo persulfate as initiator and sodium hypophosphite as molecular weight modifier followed by freeze drying of the aqueous polymer solution.

Polymer 2: Polyacrylic acid, Mw 10000 g/mol, powder, pH (10% in water) 2.0

Polymer 2 was produced by free-radical polymerization of acrylic acid in water using sodium dioxo persulfate as initiator and sodium hypophosphite as molecular weight modifier followed by freeze drying of the aqueous polymer solution.

Polymer 3: Polyacrylic acid, Mw 4000 g/mol, powder, pH (10% in water) 2.0

Polymer 3 was produced by free-radical polymerization of acrylic acid in isopropanol using hydrogen peroxide as initiator followed by isopropanol/water exchange and freeze drying of the resulting aqueous polymer solution.

Polymer 4: Polyacrylic-co-maleic acid, Mw 3000 g/mol, powder, pH (10% in water) 1.5

Polymer 4 was produced by free-radical polymerization of acrylic acid and maleic acid in water using hydrogen peroxide as initiator followed by freeze drying of the aqueous polymer solution.

Polymer 5: Polyacrylic acid, Mw 6500 g/mol, powder, pH (10% in water) 2.0

Polymer 5 was produced by free-radical polymerization of acrylic acid in water using sodium dioxo persulfate as initiator and sodium hypophosphite as molecular weight modifier followed by freeze drying of the aqueous polymer solution.

Polymer 6: Polyacrylic acid, partially neutralized, Mw 6400 g/mol, powder, pH (10% in water) 3.0

Polymer 6 was produced by free-radical polymerization of acrylic acid in water using sodium dioxo persulfate as initiator and sodium hypophosphite as molecular weight modifier. The acid polymer was partially neutralized with sodium hydroxide (5 mol % of the carboxy groups) followed by freeze drying of the aqueous polymer solution.

### Polyoxyalkylene Ether PE)

The following surfactants 1 to 3 were employed as polyoxyalkylene ether PE) in the sense of the invention for the preparation of polymer films.

Surfactant 1: C₁₃C₁₅-Oxo alcohol with 10 EO/1,5 BuO
Surfactant 2: C₁₃C₁₅-Oxo alcohol with 7 EO
Surfactant 3: polyalkylenoxide having a free hydroxyl group and being bilaterally alkyl-terminated with residues CxH2x+1/CyH2y+1 with x,y=6 to 14

### Preparation of the Polymer-Surfactant Mixtures

Into a 50 mL glass vial polymers 1 to 6 as defined above is weighed as solid. Then water is weighted and the polyether-based non-ionic surfactant 1 to 3 as defined above is weighted as liquid or as aqueous solution. The resulting ternary system is heated under stirring (600 rpm) to a temperature of 60° C. and then stirred for at least 4 hours using a magnetic bar. The resulting mixture is finally cooled-down to room temperature and left standing for 24 hours before a miscibility assessment is performed. The results are shown in tables 1 to 5.

TABLE 1
Screening of various ratios of polymer 1 (=P1) to surfactants
2 and 3 (=PE) with a fixed water content of 25 wt %

| | Mixture | | |
|---|---|---|---|
| | A | | |
| | (comparative)^{a)} | B | C |
| | P1) = 25% | P1) = 37.5% | P1) = 50% |
| | PE) = 50% | PE) = 37.5% | PE) = 25% |
| | W = 25% | W = 25% | W = 25% |
| Surfactant 2 | 4 | 2 | 2 |
| Surfactant 3 | 4 | 1 | 2 |

^{a)}ratio P1):PE) = 0.5:1
W: water
1: clear solution
2: light turbidity
3: strong turbidity
4: phase separated

TABLE 2
Screening of various water contents, with a fixed weight ratio of
polymer 1 (=P1) to surfactants 1, 2 and 3 (=PE) of 2/1

| | Mixture | | | |
|---|---|---|---|---|
| | D | | | G |
| | (comparative)^{b)} | E | F | (comparative)^{c)} |
| | P1) = 63.3% | P1) = 46.7% | P1) = 40% | P1) = 26.7% |
| | PE) = 31.7% | PE) = 23.3% | PE) = 20% | PE) = 13.3% |
| | W = 5% | W = 30% | W = 40% | W = 60% |
| Surfactant | 4 | 1 | 1 | 4 |
| 1 | | | | |
| Surfactant | 4 | 2 | 1 | not determined |
| 2 | | | | |
| Surfactant | 4 | 1 | 1 | 4 |
| 3 | | | | |

^{b)}water content 5 wt %,
^{c)}water content 60 wt %
W: water
1: clear solution
2: light turbidity
3: strong turbidity
4: phase separated

TABLE 3
Screening of mixtures of polymers 1-4 (=P1) and surfactant
2 (=PE) with a fixed water content of 40%

| | Mixture | | | | |
|---|---|---|---|---|---|
| | H | I | K | L | M |
| | polymer 1 | polymer 2 | polymer 3 | polymer 4 | polymer 3 |
| Surfactant 2 | P1) = 40% | P1) = 40% | P1) = 40% | P1) = 40% | P1) = 45% |
| | PE) = 20% | PE) = 20% | PE) = 20% | PE) = 20% | PE) = 15% |
| | W = 40% | W = 40% | W = 40% | W = 40% | W = 40% |
| Rating | 1 | 1 | 2 | 1 | 2 |

W: water
1: clear solution
2: light turbidity
3: strong turbidity
4: phase separated

TABLE 4
Screening of mixtures comprising polymer 5 (=P1), surfactant
2 (=PE) and glycerine with a fixed water content of 35%

| Mixture | N | O | P |
|---|---|---|---|
| Surfactant 2 | P1) = 35.7% | P1) = 39% | P1) = 45.5% |
| | PE) = 26% | PE) = 22.7% | PE) = 18.2% |
| | G = 3.3% | G = 3.3% | G = 3.3% |
| | W = 35% | W = 35% | W = 35% |
| Rating | 1 | 1 | 2 |

W: water;
G: glycerine
1: clear solution
2: light turbidity
3: strong turbidity
4: phase separated

TABLE 5
Screening of a mixture comprising polymer 6 (P1) and surfactant
2 (=PE) in a weight ratio of 1:1 with a water content of 20%

| Mixture | Q |
|---|---|
| | P1) = 40% |
| | PE) = 40% |
| | W = 20% |
| Rating | 1 |

W: water
1: clear solution
2: light turbidity
3: strong turbidity
4: phase separated

### Preparation of Polymer Films

To achieve stable films from the mixtures described above, those mixtures rated with 1 or 2 (clear solution resp. light turbid solution) are used. The water content of the mixture should be below 50% to avoid any negative spreading effects during the film casting process.

### General Procedure for the Production of Monolayer Films

The viscous polymer surfactant mixture is heated to 60° C. in order to convert it to a pourable form. The thus heated mixture is applied to the surface of a silicone paper using an automatic film applicator and a universal applicator from Zehntner GmbH, CH-4450 Sissach. The gap width of the coating bar is adjusted such that, after the drying at room temperature and 40% humidity, the total layer thickness of the film is 100 μm. After the drying, the films comprise 5 to 8 wt-% water.

The polymer surfactant mixture according to the invention can be formulated with at least one plasticizer. For example, the mixtures prepared by the above-described process can be mixed with 5% by weight of triethylene glycol or with 5% by weight of glycerine, based on the total weight of the resulting polymer surfactant mixture. Following the liquid application to a substrate and the drying, a transparent film is obtained which is so flexible that the two ends can be brought into contact and the film does not break. Without the use of triethylene glycol or glycerine, a stiffer film is obtained.

35 mol % of the carboxy groups of P1 in mixture I were neutralized with sodium hydroxide respectively with monoethanol amine. It was not possible to cast a stable film from each mixture.

### Thickness Measurement:

Film thicknesses were determined by means of a digital gauge (Mitutoyo Absolute Digimatic gauge, ID-H model) with a flat, circular stylus of 5 mm diameter. The thickness was determined as an average of the measurement of at least 10 positions per film. The layer thickness variations are within a range of ±10%.

### Production of Multilayer Films

In the following examples 1 and 2 that describe the production of a multilayer film, the coating was effected wet on dry.

### Production of an Application Solution a for Film Layers of Polyvinyl Alcohol (PVOH Films):

20 g of a solid polyvinyl alcohol (Poval® 26-88 from Kuraray, nonvolatile components: 97.5%) were dissolved in 80 g of deionized water at 60° C. while stirring. 5.0 g of glycerine were added to 100 g of the polyvinyl alcohol solution thus prepared. The solution was heated to 80° C. Subsequently, by addition of deionized water, the polyvinyl alcohol concentration of the solution was adjusted to 18.0% by weight. The polyvinyl alcohol application solution was mixed well and heated at 80° C. until the air stirred in had escaped completely.

### Example 1: 2-Layer Film: 1st Layer of Polyvinyl Alcohol, 2nd Layer of Polymer Film from Polymer Surfactant Mixture (Table 3, Mixture H) Comprising Additionally 5% of Glycerine

For production of the multilayer film, an automatic film applicator and a universal applicator from Zehntner GmbH, CH-4450 Sissach were used. The application solution A was applied to the surface of a polyethylene terephthalate carrier. The gap width of the coating bar was chosen such that the layer, after drying at room temperature, has a thickness of 20 μm. After the polyvinyl alcohol layer had dried, the polymer surfactant mixture N heated to 60° C. was applied. The gap width of the coating bar was adjusted such that, after the drying at room temperature, the total layer thickness of the film is 90 μm.

### Example 2: 2-Layer Film: 1st Layer of Polyvinyl Alcohol, 2nd Layer of Polymer Film from Polymer Surfactant Mixture (Table 3, Mixture I) Comprising Additionally 8% of Glycerine

For production of the multilayer film, an automatic film applicator and a universal applicator from Zehntner GmbH, CH-4450 Sissach were used. The application solution A was applied to the surface of a polyethylene terephthalate carrier. The gap width of the coating bar was chosen such that the layer, after drying at room temperature, has a thickness of 25 μm. After the polyvinyl alcohol layer had dried, the polymer surfactant mixture heated to 60° C. was applied. The gap width of the coating bar was adjusted such that, after the drying at room temperature, the total layer thickness of the film is 110 μm.

### Application Examples

The washing effect of the films according to the invention was determined as follows: Selected soiled fabrics were washed in the presence of ballast fabric made from cotton at 40° C. with the addition of the films according to the invention. After the wash cycle, the fabrics were rinsed, spun and dried. To determine the washing effect, the reflectance of the soiled fabric was measured before and after the washing using a photometer from Datacolor (Elrepho 2000) at 460 nm. The higher the reflectance value, the better the washing ability.

### Washing Conditions:

| Appliance | Launder-o-meter, LP2 model, | |
|---|---|---|
| | SDL Atlas Inc., USA | |
| Wash liquor | 250 | ml |
| Wash time/wash | 30 min at 40° C. | |
| temperature | | |
| Dosage | 1.5 g film (initial weight refers to the | |
| | solids content of the film, ascertained | |
| | after drying for 2 h in a | |
| | circulating-air cabinet at 120° C.) | |
| Liquor ratio | 1:12.5 | |
| Wash cycles | 1 | |
| Water hardness | 2.5 mmol/l Ca²⁺:Mg²⁺:HCO₃_{^{−}} 4:1:8 | |
| Ballast fabric | 10 g cotton fabric 283 | |
| Sum of ballast fabric + | 20 | g |
| soiled fabric | | |

| | |
|---|---|
| Soiled fabric | 10 g wfk 20 D ¹⁾ |
| | 10 g wfk 10 PF ²⁾ |
| | 10 g EMPA 123 ³⁾ |
| | 10 g EMPA 125 ⁴⁾ |
| | 10 g olive oil on mixed fabric ⁵⁾ |

¹⁾ wfk 20 D polyester/cotton fabric, pigment/sebum soiling, reflectance 33.9%
²⁾ wfk 10 PF cotton fabric, pigment/vegetable fat soiling, reflectance 33.8%
³⁾ EMPA 123 cotton fabric, soiling for low-temperature wash, reflectance 21.0%
⁴⁾ EMPA 125 cotton fabric for surfactant tests, reflectance 21.0%
⁵⁾ olive oil on cotton/polyester mixted fabric
^{1) 2)} Manufacturer/supplier: wfk Testgewebe GmbH, Bruggen, Germany
^{3) 4)} Manufacturer/supplier: EMPA Testmaterialien AG, Saint Gallen, Switzerland
⁵⁾ Inhouse soiling BASF SE, Ludwigshafen, Germany

Preparation: 0.1 g of olive oil mixed with 0.1% Sudan red is applied using a pipette to the middle of a mixed fabric made of polyester/cotton and weighing 5 g. The soiled fabric is stored overnight before it is washed.

### Wash Result (Evaluation % Reflectance)

| | | | | | Olive | |
|---|---|---|---|---|---|---|
| | wfk | wfk | EMPA | EMPA | oil | |
| Film | 20 D | 10 PF | 123 | 125 | on MF | Total |
| Without | 37.5 | 33.6 | 29.6 | 25.8 | 33.3 | 159.8 |
| from | 60.2 | 47.7 | 42.8 | 51.2 | 55.8 | 257.7 |
| mixture H | | | | | | |
| from | 59.6 | 48.3 | 43.9 | 50.5 | 55.7 | 258.0 |
| mixture I | | | | | | |

1. A washing- and cleaning-active polymer film, comprising at least one layer obtainable by:
a) providing an aqueous composition by mixing
a polymer P1) prepared by free-radical polymerization of a monomer composition M) that comprises at least one monomer A), selected from α,β-ethylenically unsaturated carboxylic acids, salts of α,β-ethylenically unsaturated carboxylic acids and mixtures thereof, wherein the monomer A) is used in an amount of from 50 to 100% by weight, based on the total weight of the monomer composition M),
a polyoxyalkylene ether PE) having at least one C₈-C₁₈-alkyl group that is unsubstituted or substituted by at least one hydroxyl group, and an average of 3 to 25 alkylene oxide units per molecule, and
water,
wherein at the most 30 mol % of the carboxy groups of the polymer P1) are in the deprotonated form,
the weight ratio of the polymer P1) to the polyoxyalkylene ether PE) is in a range from 0.9:1 to 5:1, and
the aqueous composition has a water content of at least 10% by weight and at most 50% by weight, based on the total weight of the aqueous composition,
b) converting the aqueous composition to a polymer film.

2. The polymer film according to claim 1, where the monomer composition M) comprises in addition at least one monomer B) which is selected from unsaturated sulfonic acids, salts of unsaturated sulfonic acids, unsaturated phosphonic acids, salts of unsaturated phosphonic acids and mixtures thereof.

3. The polymer film according to claim 1, where the monomer composition M) comprises in addition at least one monomer C) selected from
C1) nitrogen heterocycles with a free-radically polymerizable α,β-ethylenically unsaturated double bond,
C2) monomers containing amide groups,
C3) compounds of the general formulae (I.a) and (I.b) 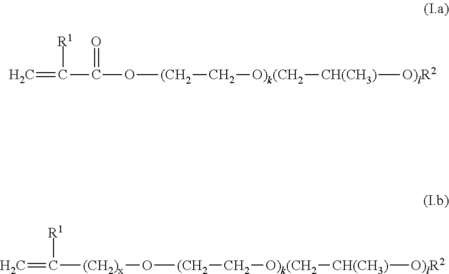
in which
the order of the alkylene oxide units is arbitrary,
x is 0, 1 or 2,
k and l, independently of one another, are an integer from 0 to 100, where the sum of k and l is at least 2,
R¹ is hydrogen or methyl,
R² is hydrogen or C₁-C₄-alkyl,
and mixtures of two or more than two of the afore-mentioned monomers C1) to C3).

4. The polymer film according to claim 1, where the polymer P1) comprises less than 0.5% by weight polymerized units of crosslinking monomers which have two or more than two free-radically polymerizable α,β-ethylenically unsaturated double bonds per molecule.

5. The polymer film according to claim 1, where the monomer A) is selected from acrylic acid, methacrylic acid, maleic acid, fumaric acid, itaconic acid, ethacrylic acid, α-chloroacrylic acid, crotonic acid, citraconic acid, mesaconic acid, glutaconic acid and aconitic acid, salts of the aforementioned carboxylic acids and mixtures thereof.

6. The polymer film according to claim 1, where the monomer A) comprises acrylic acid or consists of acrylic acid.

7. The polymer film according to claim 1, where the polymer P1) comprises less than 15% by weight polymerized units of monomers different from monomers A).

8. The polymer film according to claim 1, where the polyoxyalkylene ethers PE) comprise on average 3 to 10 alkylene oxide units per molecule.

9. The polymer film according to claim 1, wherein at the most 10 mol % of the carboxy groups of the polymer P1) are in the deprotonated form.

10. The polymer film according to claim 1, wherein the weight ratio of the polymer P1) to the polyoxyalkylene ether PE) is in a range from 0.9:1 to 4:1.

11. The polymer film according to claim 1 in form of a multilayer film comprising at least one further layer comprising or consisting of at least one polymer P2) selected from
natural and modified polysaccharides,
homo- and copolymers comprising repeat units which derive from vinyl alcohol, vinyl esters, alkoxylated vinyl alcohols or mixtures thereof,
homo- and copolymers comprising at least one copolymerized monomer selected from N-vinylpyrrolidone, N-vinylcaprolactam, N-vinylimidazole, 2-vinylpyridine, 4-vinylpyridine, salts of the three latter monomers, vinylpyridine N-oxide, N-carboxymethyl-4-vinylpyridium halides and mixtures thereof,
homo- and copolymers of acrylic acid and/or methacrylic acid, especially copolymers comprising at least one copolymerized acrylic monomer selected from acrylic acid, acrylic salts and mixtures thereof, and at least one copolymerized maleic monomer selected from maleic acid, maleic anhydride, maleic salts and mixtures thereof,
copolymers comprising at least one copolymerized (meth)acrylic monomer selected from acrylic acid, methacrylic acid, salts thereof and mixtures thereof and at least one copolymerized hydrophobic monomer selected from C₁-C₈-alkyl esters of (meth)acrylic acid, C₂-C₁₀ olefins, styrene and α-methylstyrene,
copolymers comprising at least one copolymerized maleic monomer selected from maleic acid, maleic anhydride, maleic salts and mixtures thereof and at least one copolymerized C₂-C₈ olefin,
homo- and copolymers of acrylamide and/or methacrylamide,
polyamino acids,
water-soluble or water-dispersible polyamides,
polyalkylene glycols, mono- or diethers of polyalkylene glycols, and
mixtures thereof.

12. The polymer film according to claim 1, wherein at least one of the layers comprises at least one additive and/or at least one additive is present between at least two layers, said additive being selected from nonionic, anionic, cationic and amphoteric surfactants, builders, complexing agents such as methylglycinediacetic acid, glutaminediacetic acid, glutamic acid diacetic acid and citric acid and the sodium and potassium salts thereof, bleaches, enzymes, enzyme stabilizers, bases, corrosion inhibitors, defoamers, foam inhibitors, wetting agents, dyes, pigments, fragrances, fillers, tableting aids, disintegrants, thickeners, solubilizers, organic solvents, electrolytes, pH modifiers, perfume carriers, bitter substances, fluorescers, hydrotropes, antiredeposition agents, optical brighteners, graying inhibitors, antishrink agents, anticrease agents, dye transfer inhibitors, antimicrobial active ingredients, antioxidants, anti-yellowing agents, corrosion inhibitors, antistats, ironing aids, hydrophobizing and impregnating agents, antiswell and antislip agents, plasticizers, scavengers, polymers other than the polymers P1) and the polymers P2), agents for modification of gas permeability and water vapor permeability, antistats, glidants, slip agents and UV absorbers and mixtures thereof.

13. A process for producing a washing- and cleaning-active polymer film, comprising
a) providing an aqueous composition by mixing
a polymer P1) prepared by free-radical polymerization of a monomer composition M) that comprises of at least one monomer A), selected from α,β-ethylenically unsaturated carboxylic acids, salts of α,β-ethylenically unsaturated carboxylic acids and mixtures thereof, wherein the monomer A) is used in an amount of from 50 to 100% by weight, based on the total weight of the monomer composition M),
an polyoxyalkylene ether PE) having at least one C₈-C₁₈-alkyl group that is unsubstituted or substituted by at least one hydroxyl group, and an average of 3 to 25 alkylene oxide units per molecule, and
water,
wherein at the most 30 mol % of the carboxy groups of the polymer P1) are in the deprotonated form,
the weight ratio of the polymer P1) to the polyoxyalkylene ether PE) is in a range from 0.9:1 to 5:1, and
the aqueous composition has a water content of at least 10% by weight and at most 50% by weight, based on the total weight of the aqueous composition, and
b) converting the aqueous composition to a polymer film.

14. The process according to claim 13, where in step a) the mixing is performed at temperature in the range from 25 to 100° C.

15. The process according to claim 13, where at least one additive is added to the aqueous composition prior to and/or during and/or after mixing step a).

16. A method for the at least partial covering of a liquid or solid detergent or cleaner, the method comprising a use of a polymer film as defined in claim 1.

17. A method for improving the detachment of soil from laundry (improvement of primary washing power) and/or for preventing the redeposition of detached soil on laundry (improvement of secondary washing power) and/or for preventing dye transfer, the method comprising a use of a polymer film as defined in claim 1.

18. A covering or coating for a detergent or cleaner portion, comprising a polymer film, as defined in claim 1.

19. A detergent or cleaner, comprising:
A) at least one covering and/or coating, comprising a washing- and cleaning-active polymer film as defined in claim 1,
B) at least one surfactant,
C) optionally at least one builder,
D) optionally at least one bleach system,
E) optionally at least one further additive selected from enzymes, enzyme stabilizers, bases, corrosion inhibitors, antifoams, foam inhibitors, dyes, fragrances, fillers, tableting auxiliaries, disintegrants, thickeners, solubility promoters, organic solvents, electrolytes, pH extenders, perfume carriers, bitter substances, fluorescent agents, hydrotropes, antiredeposition agents, optical brighteners, graying inhibitors, shrink preventers, anticrease agents, color transfer inhibitors, antimicrobial active ingredients, antioxidants, anti-yellowing agents, corrosion inhibitors, antistats, ironing aids, phobicization and impregnation agents, swelling and slip-resist agents and UV absorbers, and
F) optionally water.

20. A method for the at least partial covering of a liquid or solid detergent or cleaner, the method comprising a use of a polymer film obtainable by a process as defined in claim 13.
